(19) United States
(12) Patent Application Publication
(10) Pub. No.: US 2018/0067213 A1
(43) Pub. Date: Mar. 8, 2018

(54) DETECTOR FOR AN OPTICAL DETECTION OF AT LEAST ONE OBJECT

(71) Applicant: BASF SE, Ludwigshafen (DE)

(72) Inventors: Robert SEND, Karlsruhe (DE); Ingmar BRUDER, Neuleiningen (DE); Sebastian VALOUCH, Lampertheim (DE); Stephan IRLE, Siegen (DE); Erwin THIEL, Siegen (DE)

(73) Assignee: BASF SE, Ludwigshafen (DE)

(21) Appl. No.: 15/554,496

(22) PCT Filed: Mar. 3, 2016
(86) PCT No.: PCT/EP2016/054532

§ 371 Date: Aug. 30, 2017

(30) Foreign Application Priority Data
Mar. 5, 2015 (EP) 15157831.7

(51) Int. Cl. G01S 17/42; G01S 5/16; G06F 3/00; G01S 7/483; G01S 7/481

(52) U.S. Cl. CPC G01S 17/42; G01S 5/16; G01S 17/48; G01S 7/483; G01S 7/481; G06F 3/002

(57) ABSTRACT

A detector for optical detection of an object contains a modulation device generating at least one modulated light beam from the object to the detector; a longitudinal optical sensor having at least one sensor region and designed to generate at least one longitudinal sensor signal depending on an illumination of the sensor region by the modulated light beam; and an evaluation device designed to generate at least one item of information on a longitudinal position of the object. The longitudinal sensor signal contains a first component, which depends on a response of the longitudinal optical sensor to a variation of the modulation of the modulated light beam, and a second component, which depends on the total power of the illumination. The item of information is generated by deriving the first component and the second component from the longitudinal sensor signal.

### FIELD OF THE INVENTION

The invention relates to a detector for an optical detection of at least one object, in particular, for determining a position of at least one object, specifically with regard to a depth or both to the depth and to a width of the at least one object. Furthermore, the invention relates to a human-machine interface, an entertainment device, a tracking system and a camera. Further, the invention relates to a method for optical detection of at least one object and to various uses of the detector. Such devices, methods and uses can be employed for example in various areas of daily life, gaming, traffic technology, mapping of spaces, production technology, security technology, medical technology or in the sciences. However, further applications are possible.

### Prior Art

Various detectors for optically detecting at least one object are known on the basis of optical sensors.

WO 2012/110924 A1 discloses a detector comprising at least one optical sensor, wherein the optical sensor exhibits at least one sensor region. Herein, the optical sensor is designed to generate at least one sensor signal in a manner dependent on an illumination of the sensor region. According to the so-called “FiP effect”, the sensor signal, given the same total power of the illumination, is hereby dependent on a geometry of the illumination, in particular on a beam cross-section of the illumination on the sensor area. The detector furthermore has at least one evaluation device designated to generate at least one item of geometrical information from the sensor signal, in particular at least one item of geometrical information about the illumination and/or the object. As an example, the optical sensors may be or may comprise a dye-sensitized solar cell (DSC), preferably a solid dye-sensitized solar cell (sDSC).

Further, WO 2014/097181 A1 discloses a method and a detector for determining a position of at least one object, by using at least one transversal optical sensor and at least one longitudinal optical sensor. Preferably, a stack of longitudinal optical sensors is employed, in particular to determine a longitudinal position of the object with a high degree of accuracy and without ambiguity. In general, at least two individual “FiP sensors”, i.e. a optical sensors based on the FiP-effect, are required in order to determine the longitudinal position of the object without ambiguity, wherein at least one of the FiP sensors is employed for normalizing the longitudinal sensor signal for taking into account possible variations of the illumination power. Further, WO 2014/097181 A1 discloses a human-machine interface, an entertainment device, a tracking system, and a camera, each comprising at least one such detector for determining a position of at least one object.

Further, European patent application No. 15 153 215.7, filed Jan. 30, 2015, and PCT patent application No. PCT/EP2016/051817, filed Jan. 28, 2016, the full content of both is incorporated herein by reference, discloses an optical sensor comprising a photoconductive material, which may be an inorganic photoconductive material, preferably selected from the group consisting of selenium, a metal oxide, a group IV element or compound, a III-V compound, a II-VI compound, and a chalcogenide, or an organic photoconductive material.

An alternative optical detector comprising a spatial light modulator (SLM) being adapted to modify an optical property of a light beam in a spatially resolved fashion is disclosed in WO/2015/024871. Herein, the SLM has a matrix of pixels, wherein each pixel is controllable to individually modify the optical property of a portion of the light beam passing the pixel. Further, a modulator device periodically controls at least two of the pixels with different modulation frequencies. After passing the matrix of pixels of the SLM, a FiP sensor detects the light beam and generates a sensor signal, while an evaluation device performs a frequency analysis in order to determine signal components of the sensor signal for the modulation frequencies.

Despite the advantages implied by the above-mentioned devices and detectors, specifically by the detectors as disclosed in WO 2012/110924 A1, WO 2014/097181 A1, European patent application No. 15 153 215.7, filed Jan. 30, 2015, and PCT patent application No. PCT/EP2016/051817, filed Jan. 28, 2016, there still is a need for improvements with respect to a simple, cost-efficient and, still, reliable spatial detector. In particular, it would be desirable to use a low number of FiP sensors, such as a single FiP sensor, and still be able to determine a longitudinal position of the object without ambiguity.

### Problem Addressed by the Invention

Therefore, a problem addressed by the present invention is that of specifying a device and a method for optically detecting at least one object which at least substantially avoid the disadvantages of known devices and methods of this type. In particular, an improved simple, cost-efficient and, still, reliable spatial detector for determining the position of an object in space would be desirable. More particular, the problem addressed by the present invention is that of providing a detector comprising a low number of FiP sensors, such as a single FiP sensor, which, nevertheless, allows determining a longitudinal position of the object without ambiguity.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

As used herein, the expressions “have”, “comprise” and “contain” as well as grammatical variations thereof are used in a non-exclusive way. Thus, the expression “A has B” as well as the expression “A comprises B” or “A contains B” may both refer to the fact that, besides B, A contains one or more further components and/or constituents, and to the case in which, besides B, no other components, constituents or elements are present in A.

In a first aspect of the present invention, a detector for optical detection, which may also be denominated as “optical detector”, in particular, for determining a position of at least one object, specifically with regard to a depth or to both the depth and a width of the at least one object is disclosed.

The “object” generally may be an arbitrary object, chosen from a living object and a non-living object. Thus, as an example, the at least one object may comprise one or more articles and/or one or more parts of an article. Additionally or alternatively, the object may be or may comprise one or more living beings and/or one or more parts thereof, such as one or more body parts of a human being, e.g. a user, and/or an animal.

As used herein, a “position” generally refers to an arbitrary item of information on a location and/or orientation of the object in space. For this purpose, as an example, one or more coordinate systems may be used, and the position of the object may be determined by using one, two, three or more coordinates. As an example, one or more Cartesian coordinate systems and/or other types of coordinate systems may be used. In one example, the coordinate system may be a coordinate system of the detector in which the detector has a predetermined position and/or orientation. As will be outlined in further detail below, the detector may have an optical axis, which may constitute a main direction of view of the detector. The optical axis may form an axis of the coordinate system, such as a z-axis. Further, one or more additional axes may be provided, preferably perpendicular to the z-axis.

Thus, as an example, the detector may constitute a coordinate system in which the optical axis forms the z-axis and in which, additionally, an x-axis and a y-axis may be provided which are perpendicular to the z-axis and which are perpendicular to each other. As an example, the detector and/or a part of the detector may rest at a specific point in this coordinate system, such as at the origin of this coordinate system. In this coordinate system, a direction parallel or antiparallel to the z-axis may be regarded as a longitudinal direction, and a coordinate along the z-axis may be considered a longitudinal coordinate. An arbitrary direction perpendicular to the longitudinal direction may be considered a transversal direction, and an x- and/or y-coordinate may be considered a transversal coordinate.

Alternatively, other types of coordinate systems may be used. Thus, as an example, a polar coordinate system may be used in which the optical axis forms a z-axis and in which a distance from the z-axis and a polar angle may be used as additional coordinates. Again, a direction parallel or antiparallel to the z-axis may be considered a longitudinal direction, and a coordinate along the z-axis may be considered a longitudinal coordinate. Any direction perpendicular to the z-axis may be considered a transversal direction, and the polar coordinate and/or the polar angle may be considered a transversal coordinate.

As used herein, the detector for optical detection generally is a device which is adapted for providing at least one item of information on the position of the at least one object. The detector may be a stationary device or a mobile device. Further, the detector may be a stand-alone device or may form part of another device, such as a computer, a vehicle or any other device. Further, the detector may be a hand-held device. Other embodiments of the detector are feasible.

The detector may be adapted to provide the at least one item of information on the position of the at least one object in any feasible way. Thus, the information may e.g. be provided electronically, visually, acoustically or in any arbitrary combination thereof. The information may further be stored in a data storage of the detector or a separate device and/or may be provided via at least one interface, such as a wireless interface and/or a wire-bound interface.

The detector for an optical detection of at least one object according to the present invention comprises:

at least one modulation device, wherein the modulation device is capable of generating at least one modulated light beam traveling from the object to the detector;
at least one longitudinal optical sensor, wherein the longitudinal optical sensor has at least one sensor region, wherein the longitudinal optical sensor is designed to generate at least one longitudinal sensor signal in a manner dependent on an illumination of the sensor region by the modulated light beam, wherein the longitudinal sensor signal,
given the same total power of the illumination, is dependent on a beam cross-section of the modulated light beam in the sensor region,
given the same total power of the illumination, is dependent on the modulation frequency of the modulation of the illumination, and
comprises a first component and a second component, wherein the first component is dependent on a response of the longitudinal optical sensor to a variation of the modulation of the modulated light beam and the second component is dependent on the total power of the illumination; and
at least one evaluation device, wherein the evaluation device is designed to generate at least one item of information on a longitudinal position of the object by deriving the first component and the second component from the longitudinal sensor signal, wherein the item of information on the longitudinal position of the object is dependent on the first component and the second component.

Herein, the components listed above may be separate components. Alternatively, two or more of the components as listed above may be integrated into one component. Further, the at least one evaluation device may be formed as a separate evaluation device independent from the transfer device and the longitudinal optical sensors, but may preferably be connected to the longitudinal optical sensors in order to receive the longitudinal sensor signal. Alternatively, the at least one evaluation device may fully or partially be integrated into the longitudinal optical sensors.

Accordingly, the detector according to the present invention comprises at least one modulation device which is capable of generating at least one modulated light beam traveling from the object to the detector and, thus, modulates the illumination of the object and/or at least one sensor region of the detector, such as at least one sensor region of the at least one longitudinal optical sensor. Preferably, the modulation device may be employed for generating a periodic modulation, such as by employing a periodic beam interrupting device. By way of example, the detector can be designed to bring about a modulation of the illumination of the object and/or at least one sensor region of the detector, such as at least one sensor region of the at least one longitudinal optical sensor, with a frequency of 0.05 Hz to 1 MHz, such as 0.1 Hz to 10 kHz. Within this regard, the modulation of the illumination is understood to mean a process in which a total power of the illumination is varied, preferably periodically, in particular with a single modulation frequency or, simultaneously and/or consecutively, with a plurality of modulation frequencies. In particular, a periodic modulation can be effected between a maximum value and a minimum value of the total power of the illumination. Herein, the minimum value can be 0, but can also be >0, such that, by way of example, complete modulation does not have to be effected. In a particularly preferential manner, the at least one modulation may be or may comprise a periodic modulation, such as a sinusoidal modulation, a square modulation, or a triangular modulation of the affected light beam. Further, the modulation may be a linear combination of two or more sinusoidal functions, such as a squared sinusoidal function, or a sin(t²) function, where t denotes time. In order to demonstrate particular effects, advantages and feasibility of the present invention the square modulation is, in general, employed herein as an exemplary shape of the modulation which representation is, however, not intended to limit the scope of the present invention to this specific shape of the modulation. By virtue of this example, the skilled person may rather easily recognize how to adapt the related parameters and conditions when employing a different shape of the modulation.

The modulation can be effected for example in a beam path between the object and the optical sensor, for example by the at least one modulation device being arranged in said beam path. Alternatively or additionally, however, the modulation can also be effected in a beam path between an optional illumination source as described below for illuminating the object and the object, for example by the at least one modulation device being arranged within said beam path. A combination of these possibilities may also be conceivable. For this purpose, the at least one modulation device can comprise, for example, a beam chopper or some other type of periodic beam interrupting device, such as comprising at least one interrupter blade or interrupter wheel, which preferably rotates at constant speed and which can, thus, periodically interrupt the illumination. Alternatively or additionally, however, it is also possible to use one or a plurality of different types of modulation devices, for example modulation devices based on an electro-optical effect and/or an acousto-optical effect. Once again alternatively or additionally, the at least one optional illumination source itself can also be designed to generate a modulated illumination, for example by the illumination source itself having a modulated intensity and/or total power, for example a periodically modulated total power, and/or by said illumination source being embodied as a pulsed illumination source, for example as a pulsed laser. Thus, by way of example, the at least one modulation device can also be wholly or partly integrated into the illumination source. Further, alternatively or in addition, the detector may comprise at least one optional transfer device, such as a tunable lens, which may itself be designed to modulate the illumination, for example by modulating, in particular by periodically modulating, the total intensity and/or total power of an incident light beam which impinges the at least one transfer device in order to traverse it before impinging the at least one longitudinal optical sensor. Various possibilities are feasible.

Further, the detector according to the present invention comprises at least one longitudinal optical sensor, preferably a single individual longitudinal optical sensor. Herein, the longitudinal optical sensor has at least one sensor region, i.e. an area within the longitudinal optical sensor being sensitive to an illumination by an incident light beam. As used herein, the “longitudinal optical sensor” is generally a device which is designed to generate at least one longitudinal sensor signal in a manner dependent on an illumination of the sensor region by the light beam, wherein the longitudinal sensor signal, given the same total power of the illumination, is dependent, according to the so-called “FiP effect” on a beam cross-section of the light beam in the sensor region. The longitudinal sensor signal may, thus, generally be an arbitrary signal indicative of the longitudinal position, which may also be denoted as a depth. As an example, the longitudinal sensor signal may be or may comprise a digital and/or an analog signal. As an example, the longitudinal sensor signal may be or may comprise a voltage signal and/or a current signal. Additionally or alternatively, the longitudinal sensor signal may be or may comprise digital data. The longitudinal sensor signal may comprise a single signal value and/or a series of signal values. The longitudinal sensor signal may further comprise an arbitrary signal which is derived by combining two or more individual signals, such as by averaging two or more signals and/or by forming a quotient of two or more signals.

Herein, the at least one FiP sensor may be a large-area optical sensor, wherein the large-area optical sensor may exhibit a uniform sensor surface which may, thus, constitute the sensor region of the corresponding optical sensor. However, in a preferred alternative embodiment, the at least one optical sensor may be a pixelated optical sensor. Herein, the pixelated optical sensor may be established completely or at least partially by a pixel array which may comprise a number of individual sensor pixels which, in this manner, may constitute the sensor region.

Accordingly, the pixelated optical sensor may comprise any arbitrary number of sensor pixels which may be suitable or required for the respective purposes, such as in a case where the pixel array comprises least 4×4, 16×16 or 64×64 or more sensor pixels, wherein, however, other arrangements which are not square arrangements may also be feasible.

Further, given the same total power of the illumination, the longitudinal sensor signal is dependent on the modulation frequency of the modulation of the illumination. For potential embodiments of the longitudinal optical sensor and the longitudinal sensor signal, including its dependency on the beam cross-section of the light beam within the sensor region and on the modulation frequency, reference may be made to the optical sensor as disclosed in WO 2012/110924 A1 and 2014/097181 A1. Within this respect, the detector can be designed in particular to detect at least two longitudinal sensor signals in the case of different modulations, in particular at least two longitudinal sensor signals at respectively different modulation frequencies. The evaluation device can be designed to generate the geometrical information from the at least two longitudinal sensor signals. As described in WO 2012/110924 A1 and WO 2014/097181 A1, it may be possible to resolve ambiguities and/or it is possible to take account of the fact that, for example, a total power of the illumination is generally unknown.

Specifically, the FiP effect may be observed in photo detectors, such as solar cells, more preferably in organic photodetectors, such as organic semiconductor detectors. Thus, the at least one longitudinal optical sensor may comprise at least one organic semiconductor detector and/or at least one inorganic semiconductor detector. Thus, generally, the optical detector may comprise at least one semiconductor detector. Most preferably, the at least one semiconductor detector may be an organic semiconductor detector comprising at least one organic material.

Thus, as used herein, an organic semiconductor detector is an optical detector comprising at least one organic material, such as an organic dye and/or an organic semiconductor material. Besides the at least one organic material, one or more further materials may be comprised, which may be selected from organic materials or inorganic materials. Thus, the organic semiconductor detector may be designed as an all-organic semiconductor detector comprising organic materials only, or as a hybrid detector comprising one or more organic materials and one or more inorganic materials. Still, other embodiments are feasible. Thus, combinations of one or more organic semiconductor detectors and/or one or more inorganic semiconductor detectors are feasible.

In a first embodiment, the semiconductor detector may be selected from the group consisting of an organic solar cell, a dye solar cell, a dye-sensitized solar cell, a solid dye solar cell, a solid dye-sensitized solar cell. As an example, specifically in case the at least one longitudinal optical sensor provide the above-mentioned FiP-effect, the at least one optical sensor or, in case a plurality of optical sensors is provided, one or more of the optical sensors, may be or may comprise a dye-sensitized solar cell (DSC), preferably a solid dye-sensitized solar cell (sDSC). As used herein, a DSC generally refers to a setup having at least two electrodes, wherein at least one of the electrodes is at least partially transparent, wherein at least one n-semiconducting metal oxide, at least one dye and at least one electrolyte or p-semiconducting material is embedded in between the electrodes. In an sDSC, the electrolyte or p-semiconducting material is a solid material. Generally, for potential setups of sDSCs which may also be used for one or more of the optical sensors within the present invention, reference may be made to one or more of WO 2012/110924 A1, US 2012/0206336 A1, WO 2014/097181 A1 or US 2014/0291480 A1.

In a further embodiment as disclosed in the European patent application 15 153 215.7, filed Jan. 30, 2015, and PCT patent application No. PCT/EP2016/051817, filed Jan. 28, 2016, the longitudinal optical sensor according to the present invention may comprise at least one first electrode, at least one second electrode and a layer of a photoconductive material, particularly, embedded in between the first electrode and the second electrode. Herein, the photoconductive material may be an inorganic photoconductive material, preferably selected from the group consisting of selenium, tellurium, a selenium-tellurium alloy, a metal oxide, a group IV element or compound, a III-V compound, a II-VI compound, a pnictogenide, a chalcogenide (136), and a solid solution and/or a doped variant thereof. Herein, the chalcogenide may, preferably, be selected from the group consisting of a sulfide chalcogenide, a selenide chalcogenide, a telluride chalcogenide, a ternary chalcogenide, a quaternary chalcogenide, a higher chalcogenide, and a solid solution and/or a doped variant thereof. In particular, the chalcogenide may be selected from the group consisting of lead sulfide (PbS), copper indium sulfide (CIS), copper indium gallium selenide (CIGS), copper zinc tin sulfide (CZTS), lead selenide (PbSe), copper zinc tin selenide (CZTSe), cadmium telluride (CdTe), mercury cadmium telluride (HgCdTe), mercury zinc telluride (HgZnTe), lead sulfoselenide (PbSSe), copper-zinc-tin sulfur-selenium chalcogenide (CZTSSe), and a solid solution and/or a doped variant thereof. Alternatively or in addition, the pnictogenide may be selected from the group consisting of nitride pnictogenides, phosphide pnictogenides, arsenide pnictogenides, antimonide pnictogenides, ternary pnictogenides, quarternary, and higher pnictogenides. In particular, the pnictogenide may be selected from the group consisting of indium nitride (InN), gallium nitride (GaN), indium gallium nitride (InGaN), indium phosphide (InP), gallium phosphide (GaP), indium gallium phosphide (InGaP), indium arsenide (InAs), gallium arsenide (GaAs), indium gallium arsenide (InGaAs), indium antimonide (InSb), gallium antimonide (GaSb), indium gallium antimonide (InGaSb), indium gallium phosphide (InGaP), gallium arsenide phosphide (GaAsP), and aluminum gallium phosphide (AlGaP). Alternatively or in addition, the photoconductive material may be an organic photoconductive material, preferably comprising at least one conjugated aromatic molecule, in particular a dye or a pigment, and/or a mixture comprising an electron donor material and an electron acceptor material. In particular, the organic photoconductive material may comprise a compound selected from the group consisting of: phthalocyanines, naphthalocyanines, subphthalocyanines, perylenes, anthracenes, pyrenes, oligo- and polythiophenes, fullerenes, indigoid dyes, bis-azo pigments, squarylium dyes, thiapyrilium dyes, azulenium dyes, dithioketo-pyrrolopyrroles, quinacridones, dibromoanthanthrone, polyvinylcarbazole, derivatives and combinations thereof. Alternatively or in addition, the photoconductive material may also be provided as a colloidal film comprising quantum dots. However, other materials that may exhibit the above-described FiP effect may also be feasible.

Further according to the present invention, the longitudinal sensor signal comprises a first component and a second component. As used herein, the term “component” with regard to a signal, such as to an electrical signal, preferably to a voltage signal or to a current signal, in particular to the longitudinal sensor signal, refers to an observation that the respective signal exhibits at least two individual features which, in general, are independent with respect to each other. This kind of independence can usually be proved by an investigation which may reveal that at least two specific external influences may exist, wherein a variation of a single parameter corresponding to one of the specific external influences may, generally, affect the individual features in a distinctive manner, such as by generating a linear response of a first individual feature, in particular within a specific range, and by leaving a second individual feature unmodified, at least within the specific range. Their mutual independence can, generally, be attributed to the fact that a value of the signal may depend on at least two different external causes which, at least largely, do not influence each other. Herein, the term “external” may be interpreted with respect to the longitudinal optical sensor such that further optional constituents of the optical detector, such as the modulation device or an illumination device, may still be able to exert the specific external influence to the longitudinal optical sensor

Based on this interpretation, the first component of the longitudinal sensor signal depends on a response of the longitudinal optical sensor to a variation of the modulation of the light beam while the second component of the longitudinal sensor signal depends on the total power of the illumination. In a particularly preferred embodiment, the first component of the longitudinal sensor signal may be related to at least one temporal variation of the longitudinal sensor signal within the response of the longitudinal sensor signal to a variation of the modulation of the light beam impinging on the longitudinal optical sensor. Consequently, varying a parameter of the modulation, such as a frequency and/or an amplitude of the modulation, may affect the light beam impinging on the longitudinal optical sensor, which may cause a variation of the longitudinal sensor signal over time. Thus, the specific external influence “modulation of the light beam” on the longitudinal sensor signal may result in the individual feature “temporal variation of the longitudinal sensor signal”, which may be considered as the first component of the longitudinal sensor signal.

More particular, the first component of the longitudinal sensor signal may be related to at least one of a rise time and a fall time of the longitudinal sensor signal within the response of the longitudinal optical sensor to the variation of the modulation of the light beam impinging on the longitudinal optical sensor. As used herein, the term “rise time” refers to an observation that in an event in which the specific external influence comprises a step function, i.e. a function wherein the specific external influence changes instantaneously from a specific low value to a specific high value and, thus, defines a step height, the individual feature, such as the longitudinal sensor signal, requires additional time to respond to the instantaneous change. Thus, the rise time may be defined as the time required for this kind of response to rise from a first percentage to a second percentage of its final value, wherein, generally for practical reasons, values corresponding to values such as 5% or 10% of the step height may be used for the first percentage while values corresponding to values such as 90% or 95% of the step height may be used for the second percentage, respectively. However, other definitions may be feasible. Similarly, the term “fall time” may be defined as the time required for the response of the longitudinal sensor signal to an instantaneous change of the specific external influence from a specific high value to a specific low value.

In this particular embodiment, it may, thus, be especially advantageous to employ a particular shape for the temporal variation of the modulation which comprises a plurality of instantaneous changes, such as a periodic square modulation, as the specific external influence in order to be able to observe the mentioned rise times and/or fall times of the longitudinal sensor signal in a sufficient manner via a direct or an indirect kind of measurement. Accordingly, it may be advantageous to select a frequency of the modulation which may allow observing subsequent complete rise events and/or fall events of the longitudinal sensor signal without too much delay between two subsequent events. However, the skilled person is also experienced in employing adequate measures in order to derive rise times and/or fall times from other shapes of the temporal variation of the modulation with sufficient accuracy. Irrespective of the shape chosen for the modulation, the longitudinal sensor signal may, thus, comprise a first kind of temporal variations which may, generally, be adjusted to appear within a short time scale with respect to the modulation frequency. As will be explained below in more detail, this particular selection of the first component within the longitudinal optical sensor may, therefore, facilitate a detection of the first component by employing suitable detection means which are especially adapted to prove fast variations of the respective signal.

Similarly, the second component may, preferably, be related to an integral of the longitudinal sensor signal over a time interval, thus, covering a part of the response of the longitudinal sensor signal to a variation of the total power of the illumination of the sensor region. As used herein, the term “integral” refers to an area in a virtual plane comprising time as a first axis and the signal amplitude as a second axis, wherein the corresponding boundaries of the area are defined by the first axis, the temporal variation of the signal amplitude and by the lines perpendicular to the first axis at the endpoint values of the above-mentioned time interval. Consequently, varying a parameter of the total power of the illumination of the sensor region, in particular an amplitude or an intensity of the total illumination power, may cause a variation of the longitudinal sensor signal over time. Thus, the specific external influence “total power of the illumination of the sensor region” on the longitudinal sensor signal may result in the individual feature “variation of the integral of the longitudinal sensor signal over a time interval”, which may be considered as the second component of the longitudinal sensor signal. In addition, this selection of the second component may, thus, result in an observation that the longitudinal sensor signal may, generally, comprise a second kind of temporal variations which may occur within a long time scale with respect to the frequency of the modulation of the longitudinal sensor signal. As will be explained below in more detail, this particular selection of the second component within the longitudinal optical sensor may, therefore, facilitate a detection of the second component by employing suitable detection means which—in contrast to the detection of the first component—are especially adapted to prove slow variations of the respective signal.

Surprisingly, experimental observations which will be presented in more detail below have revealed that the longitudinal sensor signal in a first case, in which the longitudinal optical sensor is in the focused position, clearly deviates from the longitudinal sensor signal in a second case, in which the longitudinal optical sensor is in the defocused position, in a manner that the rise time in the second case related to the defocused state exceeds the rise time in the first case related to the focused state. Consequently, a value as derived for the rise time may, preferably, be employed to determine whether the longitudinal optical sensor is in the focused state or not. Further, analogous considerations may be performed with respect to the fall times. Although due to the longitudinal optical sensor being in the defocused position, the longitudinal optical sensor, thus, seems to work in a slower manner for lower intensities, the observation could not confirm that an efficiency of the FiP sensor may be reduced thereby.

On the other hand, the same experimental observations have further revealed that an integral under the longitudinal sensor signal in the first case substantially equals the integral under the longitudinal sensor signal in the second case as long as the longitudinal sensor signals in both cases have been recorded under the same total power of the illumination in the sensor region of the longitudinal optical sensor. Under the further assumption that the longitudinal sensor signals in both cases have ben recorded under the same modulation conditions, the longitudinal sensor signal may only dependent on a beam cross-section of the light beam, which, thus, allows easily determining this physical quantity. Further, provided the modulation remains unmodified, a change in the value of the integral under the longitudinal sensor signal may, similarly, be used to determine a change of the total power of the illumination of the sensor region of the longitudinal optical sensor. As a result, the total power of the illumination of the sensor region may, thus, on one hand, be determined and, on the other hand, be used in order to normalize the longitudinal sensor signal as determined above. According to this observation, the second component of the longitudinal sensor signal as selected here behaves independently from the first component of the longitudinal sensor signal as selected above, thus, demonstrating the feasibility of these two components for the method according to the present invention. Accordingly, a single FiP sensor, such as a single large-area longitudinal optical sensor or a single pixelated optical sensor, being present in the optical detector may, thus, be sufficient for determining at least one item of information on the longitudinal position of the object which emits or reflects the light beam causing the longitudinal sensor signal in the sensor region of the respective longitudinal optical sensor.

In a particularly preferred embodiment, the modulation device may, as described above, be adapted to periodically modulate an intensity or an amplitude of the incident light beam which impinges on the sensor region, such as by providing a repetitive square modulation of the incident light beam, whereby repetitive periods with respect to the intensity or amplitude of the incident light beam are generated. In this particular embodiment, the first component may, therefore, be related to at least one of the rise time and the fall time of the longitudinal sensor signal within at least one of the repetitive periods of the modulation, whereas the second component may be related to an integral of the longitudinal sensor signal within the at least one of the repetitive periods of the modulation which may serve as the above-mentioned time interval.

The modulation waveform and frequency can be adapted to optimize the contrast between the two components. This can be achieved for example by using a frequency fast enough that the slow component is no longer significantly present and only the fast component determines the amplitude of the signal. Optimal waveforms can also be non-periodic (such as pseudo-random) to acquire the slow and long component for different timescales within one signal sampling period. Another way to improve the method is to chirp the pulse train, for example by increasing the frequency from preferably 10 Hz to 100 Hz in order to identify the optimum sampling frequency.

The longitudinal sensor signal may, thus, comprise the first component and the second component being mutually independent, which may be transmitted to at least one evaluation device as comprised by the optical detector according to the present invention. As used herein, the term “evaluation device” generally refers to an arbitrary device designed to generate the items of information, i.e. the at least one item of information on the position of the object. As an example, the evaluation device may be or may comprise one or more integrated circuits, such as one or more application-specific integrated circuits (ASICs), and/or one or more data processing devices, such as one or more computers, preferably one or more microcomputers and/or microcontrollers. Additional components may be comprised, such as one or more preprocessing devices and/or data acquisition devices, such as one or more devices for receiving and/or preprocessing of the sensor signals, such as one or more AD-converters and/or one or more filters. As used herein, the sensor signal may generally refer to one of the longitudinal sensor signal and, if applicable, to the transversal sensor signal. Further, the evaluation device may comprise one or more data storage devices. Further, as outlined above, the evaluation device may comprise one or more interfaces, such as one or more wireless interfaces and/or one or more wire-bound interfaces.

The at least one evaluation device may be adapted to perform at least one computer program, such as at least one computer program performing or supporting the step of generating the items of information. As an example, one or more algorithms may be implemented which, by using the sensor signals as input variables, may perform a predetermined transformation into the position of the object.

The evaluation device may particularly comprise at least one data processing device, in particular an electronic data processing device, which can be designed to generate the items of information by evaluating the sensor signals. Thus, the evaluation device is designed to use the sensor signals as input variables and to generate the items of information on the transversal position and the longitudinal position of the object by processing these input variables. The processing can be done in parallel, subsequently or even in a combined manner. The evaluation device may use an arbitrary process for generating these items of information, such as by calculation and/or using at least one stored and/or known relationship. Besides the sensor signals, one or a plurality of further parameters and/or items of information can influence said relationship, for example at least one item of information about a modulation frequency. The relationship can be determined or determinable empirically, analytically or else semi-empirically. Particularly preferably, the relationship comprises at least one calibration curve, at least one set of calibration curves, at least one function or a combination of the possibilities mentioned. One or a plurality of calibration curves can be stored for example in the form of a set of values and the associated function values thereof, for example in a data storage device and/or a table. Alternatively or additionally, however, the at least one calibration curve can also be stored for example in parameterized form and/or as a functional equation. Separate relationships for processing the sensor signals into the items of information may be used. Alternatively, at least one combined relationship for processing the sensor signals is feasible. Various possibilities are conceivable and can also be combined.

By way of example, the evaluation device can be designed in terms of programming for the purpose of determining the items of information. The evaluation device can comprise in particular at least one computer, for example at least one microcomputer. Furthermore, the evaluation device can comprise one or a plurality of volatile or nonvolatile data memories. As an alternative or in addition to a data processing device, in particular at least one computer, the evaluation device can comprise one or a plurality of further electronic components which are designed for determining the items of information, for example an electronic table and in particular at least one look-up table and/or at least one application-specific integrated circuit (ASIC).

The detector has, as described above, at least one evaluation device. In particular, the at least one evaluation device can also be designed to completely or partly control or drive the detector, for example by the evaluation device being designed to control at least one illumination source and/or to control at least one modulation device of the detector. The evaluation device can be designed, in particular, to carry out at least one measurement cycle in which one or a plurality of sensor signals, such as a plurality of sensor signals, are picked up, for example a plurality of sensor signals of successively at different modulation frequencies of the illumination.

The evaluation device is designed, as described above, to generate at least one item of information on the position of the object by evaluating the at least one sensor signal. The position of the object can be static or may even comprise at least one movement of the object, for example a relative movement between the detector or parts thereof and the object or parts thereof. In this case, a relative movement can generally comprise at least one linear movement and/or at least one rotational movement. Items of movement information can for example also be obtained by comparison of at least two items of information picked up at different times, such that for example at least one item of location information can also comprise at least one item of velocity information and/or at least one item of acceleration information, for example at least one item of information about at least one relative velocity between the object or parts thereof and the detector or parts thereof. In particular, the at least one item of location information can generally be selected from: an item of information about a distance between the object or parts thereof and the detector or parts thereof, in particular an optical path length; an item of information about a distance or an optical distance between the object or parts thereof and the optional transfer device or parts thereof; an item of information about a positioning of the object or parts thereof relative to the detector or parts thereof; an item of information about an orientation of the object and/or parts thereof relative to the detector or parts thereof; an item of information about a relative movement between the object or parts thereof and the detector or parts thereof; an item of information about a two-dimensional or three-dimensional spatial configuration of the object or of parts thereof, in particular a geometry or form of the object. Generally, the at least one item of location information can therefore be selected for example from the group consisting of: an item of information about at least one location of the object or at least one part thereof; information about at least one orientation of the object or a part thereof; an item of information about a geometry or form of the object or of a part thereof, an item of information about a velocity of the object or of a part thereof, an item of information about an acceleration of the object or of a part thereof, an item of information about a presence or absence of the object or of a part thereof in a visual range of the detector.

The at least one item of location information can be specified for example in at least one coordinate system, for example a coordinate system in which the detector or parts thereof rest. Alternatively or additionally, the location information can also simply comprise for example a distance between the detector or parts thereof and the object or parts thereof. Combinations of the possibilities mentioned are also conceivable.

According to the present invention, the evaluation device is adapted for evaluating the longitudinal sensor signal of the longitudinal optical sensor by deriving the above-described first component and second component from the longitudinal sensor signal and for determining the item of information on the longitudinal position of the object from taking into account the first component and the second component. As mentioned above, both components may play a specific role within the evaluation of the longitudinal sensor signal. In a particularly preferred embodiment, one of the two components, such as the first component, may be dependent on an individual feature related to at least one temporal variation of the longitudinal sensor signal within the response of the longitudinal sensor signal to a variation of a specific external influence, preferably to a variation of the modulation of the light beam which impinges on the sensor region of the longitudinal optical sensor. Further, in this particular embodiment, the other component of the longitudinal sensor signal, such as the second component may be dependent on the total power of the illumination of the sensor region of the respective longitudinal optical sensor. In other words, in this particular embodiment, the first component of the longitudinal sensor signal may render a physical quantity which may be related to the actually desired signal while the second component of the longitudinal sensor signal may provide a value for a background quantity to be employed for normalizing the value of the physical quantity by taking into account the corresponding background. Consequently, preferably the same longitudinal sensor signal or two similar longitudinal sensor signals received from the identical longitudinal optical sensor may, thus, be used for deriving both the desired signal and the respective background signal, which, therefore, allows determining the normalized signal which is related to the longitudinal position of the object without ambiguity. This feature may particularly allow determining the reference signal related to the background and, thus, facilitating a correct interpretation of the actual signal. This feature may, therefore, be advantageous in an observation of scenes which exhibit a considerably high overall illumination intensity, such as by providing a process for taking into account a large background signal which may be prone to shift a working point of the FiP sensor.

In a preferred embodiment, the evaluation device or an appropriate separate device may, thus, comprise means for further processing both the first component and the second component of the longitudinal sensor signal. For this purpose, it may be suitable, as described above, to facilitate the detection of both the first component and the second component by employing suitable detection means which are especially adapted to distinguish between fast variations and slow variations of the longitudinal optical signal, such as by employing a signal processing unit which may be configured for performing a signal analysis with respect to a frequency spectrum of the longitudinal optical signal.

Alternatively or in addition, it can, particularly, be advantageous that the evaluation device may be adapted for determining the desired item of information on the longitudinal position of the object by separating the first component of the longitudinal sensor signal from the second component of the same longitudinal sensor signal. As used herein, the term “separating” the two components refers to determining both components independent from each other from the same longitudinal sensor signal or from two similar longitudinal sensor signals received from the identical longitudinal optical sensor, respectively. In a preferred embodiment, the evaluation device may, therefore, comprise at least one signal splitter for splitting the longitudinal sensor signal into at least two separate signals which may be further processed within the evaluation device or in a separate device independently from each other. As an example, the signal splitter may be configured for splitting the longitudinal sensor signal into two identical partial signals, wherein a first partial signal may be used for determining the first component and a second partial signal may to be used for determining the second component of the longitudinal sensor signal. However, other procedures may also be feasible, such as splitting the longitudinal sensor signal into two or more partial signals, wherein the generated partial signals may comprise identical amplitudes or not. Also, the splitting may be performed, alternatively or additionally, in a consecutive manner.

For this purpose, the evaluation device or an appropriate separate device may, thus, comprise means for further processing the at least two separate signals independently from each other. Consequently, it can be advantageous that suitable detection means may be provided here which are especially adapted to process the fast variations of the longitudinal optical signal separately from the slow variations of the longitudinal optical signal. Herein, the “fast variation” may be related to the frequency of the modulation in a manner that the fast variation may take place within a first time interval being 50%, preferably 10%, more preferably 1%, or less of a reference time interval being defined by an inverse value of the modulation frequency. Similarly, the “slow variation” may be related to the frequency of the modulation in a manner that the slow variation may take place within a second time interval being twice, preferably five times, more preferably ten times or more of the so defined reference time interval. As a particularly preferred embodiment, the evaluation device may, thus, comprise at least one high-pass filter being adapted for deriving the first component which may be related to a fast variation of the longitudinal sensor signal with respect to the modulation frequency and/or at least one low-pass filter for deriving the second component of the longitudinal sensor signal which may be related to a slow variation of the total power of the illumination of the sensor region with respect to the modulation frequency, too.

Further, the evaluation device or a separate device may comprise one or more amplifiers being adapted for amplifying the longitudinal sensor signal or a part thereof, i.e. one or more of the at least two partial signals such as generated by the at least one signal splitter, in particular before and/or after their further processing, such as by employing one or more high-pass filters and/or low-pass filters.

As already described above, the evaluation device may be or may comprise one or more integrated circuits, such as one or more application-specific integrated circuits (ASICs), and/or one or more data processing devices, such as one or more computers, preferably one or more microcomputers and/or microcontrollers. Such an embodiment may also be attributable to the additional signal processing units as described here, especially to the at least one amplifier, signal splitter, high-pass filter and low-pass filter. Consequently, the function of the additional signal processing units, such as of the at least one amplifier, signal splitter, high-pass filter and/or low-pass filter, may, thus, be implemented as part of at least one computer program, in particular of at least one computer program configured for performing or supporting the step of generating the items of information. As an example, one or more algorithms may, therefore, be implemented by which the sensor signals as input variables may perform a predetermined transformation into the position of the object which may include an implementation of the above-described functions of the additional signal processing units, in particular of those of the signal splitter, of the high-pass filter and/or of the low-pass filter.

As described above, the detector according to the present invention, preferably comprises a single individual longitudinal optical sensor. However, in a particular embodiment, such as when the different longitudinal optical sensors may exhibit different spectral sensitivities with respect to the incident light beam, the detector may comprise at least two longitudinal optical sensors, wherein each longitudinal optical sensor may be adapted to generate at least one longitudinal sensor signal. As an example, the sensor areas or the sensor surfaces of the longitudinal optical sensors may, thus, be oriented in parallel, wherein slight angular tolerances might be tolerable, such as angular tolerances of no more than 10°, preferably of no more than 5°. Herein, preferably all of the optical sensors of the detector, which may, preferably, be arranged in form of a stack along the optical axis of the detector, may be transparent. Thus, the light beam may pass through a first transparent longitudinal optical sensor before impinging on the other longitudinal optical sensors, preferably subsequently. Thus, the light beam from the object may subsequently reach all longitudinal optical sensors present in the optical detector.

Within this regard, the detector according to the present invention may comprise a stack of optical sensors as disclosed in WO 2014/097181 A1, in particular in a combination of one or more longitudinal optical sensors with one or more transversal optical sensors. As an example, one or more transversal optical sensors may be located on a side of the at least one longitudinal optical sensor facing towards the object. Alternatively or additionally, one or more transversal optical sensors may be located on a side of the at least one longitudinal optical sensor facing away from the object. Again, additionally or alternatively, one or more transversal optical sensors may be interposed in between at least two longitudinal optical sensors arranged within the stack. According to the present invention, it can, however, be advantageous that the stack of optical sensors may be a combination of a single individual longitudinal optical sensor with a single individual transversal optical sensor. However, an embodiment which may only comprise a single individual longitudinal optical sensor and no transversal optical sensor may still be advantageous, such as in a case in which determining solely the depth of the object may be desired.

As used herein, the term “transversal optical sensor” generally refers to a device which is adapted to determine a transversal position of at least one light beam traveling from the object to the detector. With regard to the term position, reference may be made to the definition above. Thus, preferably, the transversal position may be or may comprise at least one coordinate in at least one dimension perpendicular to an optical axis of the detector. As an example, the transversal position may be a position of a light spot generated by the light beam in a plane perpendicular to the optical axis, such as on a light-sensitive sensor surface of the transversal optical sensor. As an example, the position in the plane may be given in Cartesian coordinates and/or polar coordinates. Other embodiments are feasible. For potential embodiments of the transversal optical sensor, reference may be made to WO 2014/097181 A1. However, other embodiments are feasible and will be outlined in further detail below.

The transversal optical sensor may provide at least one transversal sensor signal. Herein, the transversal sensor signal may generally be an arbitrary signal indicative of the transversal position. As an example, the transversal sensor signal may be or may comprise a digital and/or an analog signal. As an example, the transversal sensor signal may be or may comprise a voltage signal and/or a current signal. Additionally or alternatively, the transversal sensor signal may be or may comprise digital data. The transversal sensor signal may comprise a single signal value and/or a series of signal values. The transversal sensor signal may further comprise an arbitrary signal which may be derived by combining two or more individual signals, such as by averaging two or more signals and/or by forming a quotient of two or more signals.

In a first embodiment similar to the disclosure according to WO 2012/110924 A1 and/or WO 2014/097181 A1, the transversal optical sensor may be a photo detector having at least one first electrode, at least one second electrode and at least one photovoltaic material, wherein the photovoltaic material may be embedded in between the first electrode and the second electrode. Thus, the transversal optical sensor may be or may comprise one or more photo detectors, such as one or more organic photodetectors and, most preferably, one or more dye-sensitized organic solar cells (DSCs, also referred to as dye solar cells), such as one or more solid dye-sensitized organic solar cells (s-DSCs). Thus, the detector may comprise one or more DSCs (such as one or more sDSCs) acting as the at least one transversal optical sensor and one or more DSCs (such as one or more sDSCs) acting as the at least one longitudinal optical sensor.

In a further embodiment as disclosed in the European patent application 15 153 215.7, filed Jan. 30, 2015, and PCT patent application No. PCT/EP2016/051817, filed Jan. 28, 2016, the full content of both is incorporated herein by reference, the transversal optical sensor according to the present invention may comprise at least one first electrode, at least one second electrode and a layer of a photoconductive material, particularly, embedded in between the first electrode and the second electrode. Thus, the transversal optical sensor may comprise one of the photoconductive materials mentioned elsewhere herein, in particular a chalcogenide, preferably, lead sulfide (PbS) or lead selenide (PbSe). Again, the layer of the photoconductive material may comprise a composition selected from a homogeneous, a crystalline, a polycrystalline, a nanocrystalline and/or an amorphous phase. Preferably, the layer of the photoconductive material may be embedded in between two layers of a transparent conducting oxide, preferably comprising indium tin oxide (ITO), aluminum-doped zinc oxide (AZO) or fluorine-doped tin oxide (FTO), which may serve as the first electrode and the second electrode. However, other materials may be feasible, in particular according to the desired transparency range within the optical spectrum.

Further, at least two electrodes may be present for recording the transversal optical signal. Preferably, the at least two electrodes may actually be arranged in the form of at least two physical electrodes, wherein each physical electrode may comprise an electrically conducting material, preferably a metallically conducting material, more preferred a highly metallically conducting material such as copper, silver, gold or an alloy or a composition comprising these kinds of materials. Herein, each of the at least two physical electrodes may, preferably, be arranged in a manner that a direct electrical contact between the respective electrode and the photoconductive layer in the optical sensor may be achieved, particularly in order to acquire the longitudinal sensor signal with as little loss as possible, such as due to additional resistances in a transport path between the optical sensor and the evaluation device.

Preferably, at least one of the electrodes of the transversal optical sensor may be a split electrode having at least two partial electrodes, wherein the transversal optical sensor may have a sensor area, wherein the at least one transversal sensor signal may indicate an x- and/or a y-position of the incident light beam within the sensor area. The sensor area may be a surface of the photo detector facing towards the object. The sensor area preferably may be oriented perpendicular to the optical axis. Thus, the transversal sensor signal may indicate a position of a light spot generated by the light beam in a plane of the sensor area of the transversal optical sensor. Generally, as used herein, the term “partial electrode” refers to an electrode out of a plurality of electrodes, adapted for measuring at least one current and/or voltage signal, preferably independent from other partial electrodes. Thus, in case a plurality of partial electrodes is provided, the respective electrode is adapted to provide a plurality of electric potentials and/or electric currents and/or voltages via the at least two partial electrodes, which may be measured and/or used independently.

The transversal optical sensor may further be adapted to generate the transversal sensor signal in accordance with the electrical currents through the partial electrodes. Thus, a ratio of electric currents through two horizontal partial electrodes may be acquired, thereby generating an x-coordinate, and/or a ratio of electric currents through to vertical partial electrodes may be generated, thereby generating a y-coordinate. The detector, preferably the transversal optical sensor and/or the evaluation device, may be adapted to derive the information on the transversal position of the object from at least one ratio of the currents through the partial electrodes. Other ways of generating position coordinates by comparing currents through the partial electrodes are feasible.

The partial electrodes may generally be defined in various ways, in order to determine a position of the light beam in the sensor area. Thus, two or more horizontal partial electrodes may be provided in order to determine a horizontal coordinate or x-coordinate, and two or more vertical partial electrodes may be provided in order to determine a vertical coordinate or y-coordinate. Thus, the partial electrodes may be provided at a rim of the sensor area, wherein an interior space of the sensor area remains free and may be covered by one or more additional electrode materials. As will be outlined in further detail below, the additional electrode material preferably may be a transparent additional electrode material, such as a transparent metal and/or a transparent conductive oxide and/or, most preferably, a transparent conductive polymer.

By using the transversal optical sensor, wherein one of the electrodes may be a split electrode with three or more partial electrodes, currents through the partial electrodes may be dependent on a position of the light beam in the sensor area. This may generally be due to the fact that Ohmic losses or resistive losses may occur on the way from a location of generation of electrical charges due to the impinging light onto the partial electrodes. Thus, besides the partial electrodes, the split electrode may comprise one or more additional electrode materials connected to the partial electrodes, wherein the one or more additional electrode materials provide an electrical resistance. Thus, due to the Ohmic losses on the way from the location of generation of the electric charges to the partial electrodes through with the one or more additional electrode materials, the currents through the partial electrodes depend on the location of the generation of the electric charges and, thus, to the position of the light beam in the sensor area. For details of this principle of determining the position of the light beam in the sensor area, reference may be made to the preferred embodiments below and/or to the physical principles and device options as disclosed in WO 2014/097181 A1 and the respective references therein.

Accordingly, the transversal optical sensor may comprise the sensor area, which, preferably, may be transparent to the light beam travelling from the object to the detector. The transversal optical sensor may, therefore, be adapted to determine a transversal position of the light beam in one or more transversal directions, such as in the x- and/or in the y-direction. For this purpose, the at least one transversal optical sensor may further be adapted to generate at least one transversal sensor signal. Thus, the evaluation device may be designed to generate at least one item of information on a transversal position of the object by evaluating the transversal sensor signal of the longitudinal optical sensor.

Further embodiments of the present invention referred to the nature of the light beam which propagates from the object to the detector. As used herein, the term “light” generally refers to electromagnetic radiation in one or more of the visible spectral range, the ultraviolet spectral range and the infrared spectral range. Therein, the term visible spectral range generally refers to a spectral range of 380 nm to 780 nm. The term infrared (IR) spectral range generally refers to electromagnetic radiation in the range of 780 nm to 1000 μm, wherein the range of 780 nm to 1.4 μm is usually denominated as the near infrared (NIR) spectral range, and the range from 15 μm to 1000 μm as the far infrared (FIR) spectral range. The term ultraviolet spectral range generally refers to electromagnetic radiation in the range of 1 nm to 380 nm, preferably in the range of 100 nm to 380 nm. Preferably, light as used within the present invention is visible light, i.e. light in the visible spectral range.

The term “light beam” generally refers to an amount of light emitted into a specific direction. Thus, the light beam may be a bundle of the light rays having a predetermined extension in a direction perpendicular to a direction of propagation of the light beam. Preferably, the light beam may be or may comprise one or more Gaussian light beams which may be characterized by one or more Gaussian beam parameters, such as one or more of a beam waist, a Rayleigh-length or any other beam parameter or combination of beam parameters suited to characterize a development of a beam diameter and/or a beam propagation in space.

The light beam might be admitted by the object itself, i.e. might originate from the object. Additionally or alternatively, another origin of the light beam is feasible. Thus, as will be outlined in further detail below, one or more illumination sources might be provided which illuminate the object, such as by using one or more primary rays or beams, such as one or more primary rays or beams having a predetermined characteristic. In the latter case, the light beam propagating from the object to the detector might be a light beam which is reflected by the object and/or a reflection device connected to the object.

As outlined above, the at least one longitudinal sensor signal, given the same total power of the illumination by the light beam, is, according to the FiP effect, dependent on a beam cross-section of the light beam in the sensor region of the at least one longitudinal optical sensor. As used herein, the term beam cross-section generally refers to a lateral extension of the light beam or a light spot generated by the light beam at a specific location. In case a circular light spot is generated, a radius, a diameter or a Gaussian beam waist or twice the Gaussian beam waist may function as a measure of the beam cross-section. In case non-circular light-spots are generated, the cross-section may be determined in any other feasible way, such as by determining the cross-section of a circle having the same area as the non-circular light spot, which is also referred to as the equivalent beam cross-section. Within this regard, it may be possible to employ the observation of an extremum, i.e. a maximum or a minimum, of the longitudinal sensor signal, inn particular a global extremum, under a condition in which the corresponding material, such as a photovoltaic material, may be impinged by a light beam with the smallest possible cross-section, such as when the material may be located at or near a focal point as affected by an optical lens. In case the extremum is a maximum, this observation may be denominated as the positive FiP-effect, while in case the extremum is a minimum, this observation may be denominated as the negative FiP-effect.

Thus, irrespective of the material actually comprised in the sensor region but given the same total power of the illumination of the sensor region by the light beam, a light beam having a first beam diameter or beam cross-section may generate a first longitudinal sensor signal, whereas a light beam having a second beam diameter or beam-cross section being different from the first beam diameter or beam cross-section generates a second longitudinal sensor signal being different from the first longitudinal sensor signal. As described in WO 2012/110924 A1, by comparing the longitudinal sensor signals, at least one item of information on the beam cross-section, specifically on the beam diameter, may be generated. Accordingly, the longitudinal sensor signals generated by the longitudinal optical sensors may be compared, in order to gain information on the total power and/or intensity of the light beam and/or in order to normalize the longitudinal sensor signals and/or the at least one item of information on the longitudinal position of the object for the total power and/or total intensity of the light beam. Thus, as an example, a maximum value of the longitudinal optical sensor signals may be detected, and all longitudinal sensor signals may be divided by this maximum value, thereby generating normalized longitudinal optical sensor signals, which, then, may be transformed by using the above-mentioned known relationship, into the at least one item of longitudinal information on the object. Other ways of normalization are feasible, such as a normalization using a mean value of the longitudinal sensor signals and dividing all longitudinal sensor signals by the mean value. Other options are possible.

However, according to the present invention, a different way of normalization may be employed in order to render the information independent from the total power and/or intensity of the light beam. As described above, the longitudinal sensor signal comprises a first component and a second component, wherein the first component may be dependent on an individual feature related to at least one temporal variation of the longitudinal sensor signal within the response of the longitudinal sensor signal to a variation of a specific external influence, preferably to a variation of the modulation of the light beam which impinges on the sensor region of the longitudinal optical sensor, while the second component may be dependent on the total power of the illumination of the sensor region of the respective longitudinal optical sensor. By using the evaluation device it is, therefore, possible to determine the item of information on the longitudinal position of the object from the first component which may render the physical quantity related to the actually desired signal by taking account the second component which may provide a value for a background quantity which may be used for normalizing the value of the physical quantity. Thus, preferably the same longitudinal sensor signal or two similar longitudinal sensor signals as received from the identical longitudinal optical sensor may be used for deriving both the desired signal and the respective background signal, which, as described above, may allow determining the normalized signal related to the longitudinal position of the object without ambiguity. In addition, information on the total power and/or the intensity of the incident light beam might, thus, also be generated.

This embodiment may, particularly, be used by the evaluation device in order to resolve an ambiguity in the known relationship between a beam cross-section of the light beam and the longitudinal position of the object. Thus, even if the beam properties of the light beam propagating from the object to the detector are known fully or partially, it is known that, in many beams, the beam cross-section narrows before reaching a focal point and, afterwards, widens again. Thus, before and after the focal point in which the light beam has the narrowest beam cross-section, positions along the axis of propagation of the light beam occur in which the light beam has the same cross-section. Thus, as an example, at a distance z0 before and after the focal point, the cross-section of the light beam is identical. Thus, in case the optical detector only comprises a single longitudinal optical sensor, a specific cross-section of the light beam might be determined, in case the overall power or intensity of the light beam is known. By using this information, the distance z0 of the respective longitudinal optical sensor from the focal point might be determined. However, in order to determine whether the respective longitudinal optical sensor may be located before or behind the focal point, additional information is required, such as a history of movement of the object and/or the detector and/or information on whether the detector is located before or behind the focal point. As described in WO 2012/110924 A1 or in WO 2014/097181 A1, this additional information may not be provided under all circumstances. However, the present invention may, particularly, be employed to provide this additional information being sufficient to resolve the above-mentioned ambiguity. Since the evaluation device according to the present invention is in the position, by evaluating the longitudinal sensor signals, to determine both the actual signal for determining the item of information on the position of the object from the first component of the longitudinal optical signal and the additional information relating to the total power and/or total intensity of illumination from the second component of the longitudinal optical signal, the normalized signal related to the longitudinal position of the object may, thus, be acquired without ambiguity already by employing a single longitudinal optical sensor. However, for various reasons it can still be feasible to use more than one longitudinal optical sensor in the detector. As an example, for distinguishing between different spectral ranges, such as between three basic colors which may be denominated as red, green, and blue, it may be feasible to employ two or more longitudinal optical sensors which may exhibit a different spectral sensitivity and, still, to separately determine the normalized signal for each of the mentioned spectral ranges.

In addition, in case one or more beam properties of the light beam propagating from the object to the detector are known, the at least one item of information on the longitudinal position of the object may thus be derived from a known relationship between the at least one longitudinal sensor signal and a longitudinal position of the object. The known relationship may be stored in the evaluation device as an algorithm and/or as one or more calibration curves. As an example, specifically for Gaussian beams, a relationship between a beam diameter or beam waist and a position of the object may easily be derived by using the Gaussian relationship between the beam waist and a longitudinal coordinate. Thus, as described in WO 2014/097181 A1, also according to the present invention, the evaluation device may be adapted to compare the beam cross-section and/or the diameter of the light beam with known beam properties of the light beam in order to determine the at least one item of information on the longitudinal position of the object, preferably from a known dependency of a beam diameter of the light beam on at least one propagation coordinate in a direction of propagation of the light beam and/or from a known Gaussian profile of the light beam.

In addition to the at least one longitudinal coordinate of the object, at least one transversal coordinate of the object may be determined. Thus, generally, the evaluation device may further be adapted to determine at least one transversal coordinate of the object by determining a position of the light beam on the at least one transversal optical sensor, which may be a pixelated, a segmented or a large-area transversal optical sensor, as further outlined also in WO 2014/097181 A1.

In addition, the detector may comprise at least one transfer device, such as an optical lens, in particular one or more refractive lenses, particularly converging thin refractive lenses, such as convex or biconvex thin lenses, and/or one or more convex mirrors, which may further be arranged along the common optical axis. Most preferably, the light beam which emerges from the object may in this case travel first through the at least one transfer device and thereafter through the single transparent longitudinal optical sensor or the stack of the transparent longitudinal optical sensors until it may finally impinge on an imaging device. As used herein, the term “transfer device” refers to an optical element which may be configured to transfer the at least one light beam emerging from the object to optical sensors within the detector, i.e. the at least two longitudinal optical sensors and the at least one optional transversal optical sensor. Thus, the transfer device can be designed to feed light propagating from the object to the detector to the optical sensors, wherein this feeding can optionally be effected by means of imaging or else by means of non-imaging properties of the transfer device. In particular the transfer device can also be designed to collect the electromagnetic radiation before the latter is fed to the transversal and/or longitudinal optical sensor.

In addition, the transfer device may also be employed for modulating light beams, such as by using a modulating transfer device. Herein, the modulating transfer device may be adapted to modulate the frequency and/or the intensity of an incident light beam before the light beam might impinge on the longitudinal optical sensor. Herein, the modulating transfer device may comprise means for modulating light beams and/or may be controlled by the modulation device, which may be constituent part of the evaluation device and/or may be at least partially implemented as a separate unit.

In addition, the at least one transfer device may have imaging properties. Consequently, the transfer device comprises at least one imaging element, for example at least one lens and/or at least one curved mirror, since, in the case of such imaging elements, for example, a geometry of the illumination on the sensor region can be dependent on a relative positioning, for example a distance, between the transfer device and the object. As used herein, the transfer device may be designed in such a way that the electromagnetic radiation which emerges from the object is transferred completely to the sensor region, for example is focused completely onto the sensor region, in particular the sensor area, in particular if the object is arranged in a visual range of the detector.

Generally, the detector may further comprise at least one imaging device, i.e. a device capable of acquiring at least one image. The imaging device can be embodied in various ways. Thus, the imaging device can be for example part of the detector in a detector housing. Alternatively or additionally, however, the imaging device can also be arranged outside the detector housing, for example as a separate imaging device. Alternatively or additionally, the imaging device can also be connected to the detector or even be part of the detector. In a preferred arrangement, the stack of the transparent longitudinal optical sensors and the imaging device are aligned along a common optical axis along which the light beam travels. Thus, it may be possible to locate an imaging device in the optical path of the light beam in a manner that the light beam travels through the stack of the transparent longitudinal optical sensors until it impinges on the imaging device. However, other arrangements are possible.

As used herein, an “imaging device” is generally understood as a device which can generate a one-dimensional, a two-dimensional, or a three-dimensional image of the object or of a part thereof. In particular, the detector, with or without the at least one optional imaging device, can be completely or partly used as a camera, such as an IR camera, or an RGB camera, i.e. a camera which is designed to deliver the three basic colors which are designated as red, green, and blue, on three separate connections. Thus, as an example, the at least one imaging device may be or may comprise at least one imaging device selected from the group consisting of: a pixelated organic camera element, preferably a pixelated organic camera chip; a pixelated inorganic camera element, preferably a pixelated inorganic camera chip, more preferably a CCD- or CMOS-chip; a monochrome camera element, preferably a monochrome camera chip; a multicolor camera element, preferably a multicolor camera chip; a full-color camera element, preferably a full-color camera chip. The imaging device may be or may comprise at least one device selected from the group consisting of a monochrome imaging device, a multi-chrome imaging device and at least one full color imaging device. A multi-chrome imaging device and/or a full color imaging device may be generated by using filter techniques and/or by using intrinsic color sensitivity or other techniques, as the skilled person will recognize. Other embodiments of the imaging device are also possible.

The imaging device may be designed to image a plurality of partial regions of the object successively and/or simultaneously. By way of example, a partial region of the object can be a one-dimensional, a two-dimensional, or a three-dimensional region of the object which is delimited for example by a resolution limit of the imaging device and from which electromagnetic radiation emerges. In this context, imaging should be understood to mean that the electromagnetic radiation which emerges from the respective partial region of the object is fed into the imaging device, for example by means of the at least one optional transfer device of the detector. The electromagnetic rays can be generated by the object itself, for example in the form of a luminescent radiation. Alternatively or additionally, the at least one detector may comprise at least one illumination source for illuminating the object.

In particular, the imaging device can be designed to image sequentially, for example by means of a scanning method, in particular using at least one row scan and/or line scan, the plurality of partial regions sequentially. However, other embodiments are also possible, for example embodiments in which a plurality of partial regions is simultaneously imaged. The imaging device is designed to generate, during this imaging of the partial regions of the object, signals, preferably electronic signals, associated with the partial regions. The signal may be an analogue and/or a digital signal. By way of example, an electronic signal can be associated with each partial region. The electronic signals can accordingly be generated simultaneously or else in a temporally staggered manner. By way of example, during a row scan or line scan, it is possible to generate a sequence of electronic signals which correspond to the partial regions of the object, which are strung together in a line, for example. Further, the imaging device may comprise one or more signal processing devices, such as one or more filters and/or analogue-digital-converters for processing and/or preprocessing the electronic signals.

Light emerging from the object can originate in the object itself, but can also optionally have a different origin and propagate from this origin to the object and subsequently toward the optical sensors. The latter case can be effected for example by at least one illumination source being used. The illumination source can be embodied in various ways. Thus, the illumination source can be for example part of the detector in a detector housing. Alternatively or additionally, however, the at least one illumination source can also be arranged outside a detector housing, for example as a separate light source. The illumination source can be arranged separately from the object and illuminate the object from a distance. Alternatively or additionally, the illumination source can also be connected to the object or even be part of the object, such that, by way of example, the electromagnetic radiation emerging from the object can also be generated directly by the illumination source. By way of example, at least one illumination source can be arranged on and/or in the object and directly generate the electromagnetic radiation by means of which the sensor region is illuminated. This illumination source can for example be or comprise an ambient light source and/or may be or may comprise an artificial illumination source. By way of example, at least one infrared emitter and/or at least one emitter for visible light and/or at least one emitter for ultraviolet light can be arranged on the object. By way of example, at least one light emitting diode and/or at least one laser diode can be arranged on and/or in the object. The illumination source can comprise in particular one or a plurality of the following illumination sources: a laser, in particular a laser diode, although in principle, alternatively or additionally, other types of lasers can also be used; a light emitting diode; an incandescent lamp; a neon light; a flame source; an organic light source, in particular an organic light emitting diode; a structured light source. Alternatively or additionally, other illumination sources can also be used. It is particularly preferred if the illumination source is designed to generate one or more light beams having a Gaussian beam profile, as is at least approximately the case for example in many lasers. For further potential embodiments of the optional illumination source, reference may be made to one of WO 2012/110924 A1 and WO 2014/097181 A1. Still, other embodiments are feasible.

The at least one optional illumination source generally may emit light in at least one of: the ultraviolet spectral range, preferably in the range of 200 nm to 380 nm; the visible spectral range (380 nm to 780 nm); the infrared spectral range, preferably in the range of 780 nm to 3.0 micrometers. Most preferably, the at least one illumination source is adapted to emit light in the visible spectral range, preferably in the range of 500 nm to 780 nm, most preferably at 650 nm to 750 nm or at 690 nm to 700 nm. Herein, it is particularly preferred when the illumination source may exhibit a spectral range which may be related to the spectral sensitivities of the longitudinal sensors, particularly in a manner to ensure that the longitudinal sensor which may be illuminated by the respective illumination source may provide a sensor signal with a high intensity which may, thus, enable a high-resolution evaluation with a sufficient signal-to-noise-ratio.

In a further aspect of the present invention, an arrangement comprising at least two detectors according to any of the preceding embodiments is proposed. Herein, the at least two detectors preferably may have identical optical properties but might also be different with respect from each other. In addition, the arrangement may further comprise at least one illumination source. Herein, the at least one object might be illuminated by using at least one illumination source which generates primary light, wherein the at least one object elastically or inelastically reflects the primary light, thereby generating a plurality of light beams which propagate to one of the at least two detectors. The at least one illumination source may form or may not form a constituent part of each of the at least two detectors. By way of example, the at least one illumination source itself may be or may comprise an ambient light source and/or may be or may comprise an artificial illumination source. This embodiment is preferably suited for an application in which at least two detectors, preferentially two identical detectors, are employed for acquiring depth information, in particular, for the purpose to providing a measurement volume which extends the inherent measurement volume of a single detector.

In a further aspect of the present invention, a human-machine interface for exchanging at least one item of information between a user and a machine is proposed. The human-machine interface as proposed may make use of the fact that the above-mentioned detector in one or more of the embodiments mentioned above or as mentioned in further detail below may be used by one or more users for providing information and/or commands to a machine. Thus, preferably, the human-machine interface may be used for inputting control commands.

The human-machine interface comprises at least one detector according to the present invention, such as according to one or more of the embodiments disclosed above and/or according to one or more of the embodiments as disclosed in further detail below, wherein the human-machine interface is designed to generate at least one item of geometrical information of the user by means of the detector wherein the human-machine interface is designed to assign the geometrical information to at least one item of information, in particular to at least one control command.

In a further aspect of the present invention, an entertainment device for carrying out at least one entertainment function is disclosed. As used herein, an entertainment device is a device which may serve the purpose of leisure and/or entertainment of one or more users, in the following also referred to as one or more players. As an example, the entertainment device may serve the purpose of gaming, preferably computer gaming. Additionally or alternatively, the entertainment device may also be used for other purposes, such as for exercising, sports, physical therapy or motion tracking in general. Thus, the entertainment device may be implemented into a computer, a computer network or a computer system or may comprise a computer, a computer network or a computer system which runs one or more gaming software programs.

The entertainment device comprises at least one human-machine interface according to the present invention, such as according to one or more of the embodiments disclosed above and/or according to one or more of the embodiments disclosed below. The entertainment device is designed to enable at least one item of information to be input by a player by means of the human-machine interface. The at least one item of information may be transmitted to and/or may be used by a controller and/or a computer of the entertainment device.

In a further aspect of the present invention, a tracking system for tracking the position of at least one movable object is provided. As used herein, a tracking system is a device which is adapted to gather information on a series of past positions of the at least one object or at least one part of an object. Additionally, the tracking system may be adapted to provide information on at least one predicted future position of the at least one object or the at least one part of the object. The tracking system may have at least one track controller, which may fully or partially be embodied as an electronic device, preferably as at least one data processing device, more preferably as at least one computer or microcontroller. Again, the at least one track controller may comprise the at least one evaluation device and/or may be part of the at least one evaluation device and/or might fully or partially be identical to the at least one evaluation device.

The tracking system comprises at least one detector according to the present invention, such as at least one detector as disclosed in one or more of the embodiments listed above and/or as disclosed in one or more of the embodiments below. Herein, the tracking system may comprise one or more detectors having at least one large-area longitudinal optical sensor or, preferably, at least one pixelated optical sensor. The embodiment comprising the pixelated optical sensor may be particularly useful in an event in which only one or a few objects may be tracked by a single pixel of the pixelated optical sensor. As mentioned above, the pixelated optical sensor as described herein particularly allows determining the reference signal related to the background and, thus, facilitates a correct interpretation of the actual signal such that the relevant features of the object may easily be tracked. This feature may particularly be advantageous in an observation of scenes exhibiting a considerably high overall illumination intensity.

The tracking system further comprises at least one track controller. The tracking system may comprise one, two or more detectors, particularly two or more identical detectors, which allow for a reliable acquisition of depth information about the at least one object in an overlapping volume between the two or more detectors. The track controller is adapted to track a series of positions of the object, each position comprising at least one item of information on a position of the object at a specific point in time.

The tracking system may further comprise at least one beacon device connectable to the object. For a potential definition of the beacon device, reference may be made to WO 2014/097181 A1. The tracking system preferably is adapted such that the detector may generate an information on the position of the object of the at least one beacon device, in particular to generate the information on the position of the object which comprises a specific beacon device exhibiting a specific spectral sensitivity. Thus, more than one beacon exhibiting a different spectral sensitivity may be tracked by the detector of the present invention, preferably in a simultaneous manner. Herein, the beacon device may fully or partially be embodied as an active beacon device and/or as a passive beacon device. As an example, the beacon device may comprise at least one illumination source adapted to generate at least one light beam to be transmitted to the detector. Additionally or alternatively, the beacon device may comprise at least one reflector adapted to reflect light generated by an illumination source, thereby generating a reflected light beam to be transmitted to the detector.

In a further aspect of the present invention, a camera for imaging at least one object is disclosed. The camera comprises at least one detector according to the present invention, such as disclosed in one or more of the embodiments given above or given in further detail below. Thus, the detector may be part of a photographic device, specifically of a digital camera. Specifically, the detector may be used for 3D photography, specifically for digital 3D photography. Thus, the detector may form a digital 3D camera or may be part of a digital 3D camera. As used herein, the term “photography” generally refers to the technology of acquiring image information of at least one object. As further used herein, a “camera” generally is a device adapted for performing photography. As further used herein, the term “digital photography” generally refers to the technology of acquiring image information of at least one object by using a plurality of light-sensitive elements adapted to generate electrical signals indicating an intensity of illumination, preferably digital electrical signals. As further used herein, the term “3D photography” generally refers to the technology of acquiring image information of at least one object in three spatial dimensions. Accordingly, a 3D camera is a device adapted for performing 3D photography. The camera generally may be adapted for acquiring a single image, such as a single 3D image, or may be adapted for acquiring a plurality of images, such as a sequence of images. Thus, the camera may also be a video camera adapted for video applications, such as for acquiring digital video sequences.

Thus, generally, the present invention further refers to a camera, specifically a digital camera, more specifically a 3D camera or digital 3D camera, for imaging at least one object. As outlined above, the term imaging, as used herein, generally refers to acquiring image information of at least one object. The camera comprises at least one detector according to the present invention. The camera, as outlined above, may be adapted for acquiring a single image or for acquiring a plurality of images, such as image sequence, preferably for acquiring digital video sequences. Thus, as an example, the camera may be or may comprise a video camera. In the latter case, the camera preferably comprises a data memory for storing the image sequence.

In a further aspect of the present invention, a method for determining a position of at least one object is disclosed. The method preferably may make use of at least one detector according to the present invention, such as of at least one detector according to one or more of the embodiments disclosed above or disclosed in further detail below. Thus, for optional embodiments of the method, reference might be made to the description of the various embodiments of the detector.

The method comprises the following steps, which may be performed in the given order or in a different order. Further, additional method steps might be provided which are not listed. Further, two or more or even all of the method steps might be performed simultaneously, at least partially. Further, two or more or even all of the method steps might be performed twice or even more than twice, repeatedly.

The method according to the present invention comprises the following steps:
generating at least one longitudinal sensor signal by using at least one longitudinal optical sensor, wherein the longitudinal sensor signal is dependent on an illumination of a sensor region of the longitudinal optical sensor by a modulated light beam, wherein the longitudinal sensor signal, given the same total power of the illumination, is dependent on a beam cross-section of the modulated light beam in the sensor region and on the modulation frequency of the modulation of the illumination, wherein the longitudinal sensor signal comprises a first component and a second component, wherein the first component is dependent on a response of the longitudinal optical sensor to a variation of the modulation of the modulated light beam and the second component is dependent on the total power of the illumination; and
evaluating the longitudinal sensor signal of the longitudinal optical sensor by deriving the first component and the second component from the longitudinal sensor signal, wherein the item of information on the longitudinal position of the object is determined by using the first component and the second component.

Herein, determining the item of information on the longitudinal position of the object may, in particular, be determined by normalizing the first component by using the second component. For further details concerning the method according to the present invention, reference may be made to the description of the optical detector as provided above and/or below.

In a further aspect of the present invention, a use of a detector according to the present invention is disclosed. Therein, a use of the detector for a purpose of determining a position, in particular a depth, of an object is proposed, in particular, for a purpose of use selected from the group consisting of: a distance measurement, in particular in traffic technology; a position measurement, in particular in traffic technology; an entertainment application; a security application; a human-machine interface application; a tracking application; a photography application; an imaging application or camera application; a mapping application for generating maps of at least one space.

Preferably, for further potential details of the optical detector, the method, the human-machine interface, the entertainment device, the tracking system, the camera and the various uses of the detector, in particular with regard to the transfer device, the longitudinal optical sensors, the evaluation device and, if applicable, to the transversal optical sensor, the modulation device, the illumination source and the imaging device, specifically with respect to the potential materials, setups and further details, reference may be made to one or more of WO 2012/110924 A1, US 2012/206336 A1, WO 2014/097181 A1, and US 2014/291480 A1, the full content of all of which is herewith included by reference.

The above-described detector, the method, the human-machine interface and the entertainment device and also the proposed uses have considerable advantages over the prior art. Thus, generally, a simple and, still, efficient detector for an accurate determining a position of at least one object in space may be provided. Therein, as an example, three-dimensional coordinates of an object or a part thereof may be determined in a fast and efficient way without ambiguity.

As compared to devices known in the art, the detector as proposed provides a high degree of simplicity, specifically with regard to an optical setup of the detector. Thus, in principle, employing a modulation device which generates a modulated light beam impinging on the sensor region of the longitudinal optical sensor in conjunction with an appropriate evaluation device adapted for receiving the longitudinal sensor signal comprising a first component related to the actual signal and a second component related to the total power of illumination of the sensor region and determining therefrom the first component and the second component, is sufficient for reliable high precision position detection without ambiguity. This high degree of simplicity, in particular due to a possible use of only a single FiP sensor, such as a single longitudinal optical sensor or a single pixelated optical sensor, and a single transversal optical sensor, in combination with the possibility of high precision measurements, is specifically suited for machine control, such as in human-machine interfaces and, more preferably, in gaming and tracking. Thus, cost-efficient entertainment devices may be provided which may be used for a large number of gaming and tracking purposes.

Summarizing, in the context of the present invention, the following embodiments are regarded as particularly preferred:

Embodiment 1: A detector for an optical detection of at least one object, comprising:
at least one modulation device, wherein the modulation device is capable of generating at least one modulated light beam traveling from the object to the detector;
at least one longitudinal optical sensor, wherein the longitudinal optical sensor has at least one sensor region, wherein the longitudinal optical sensor is designed to generate at least one longitudinal sensor signal in a manner dependent on an illumination of the sensor region by the modulated light beam, wherein the longitudinal sensor signal, given the same total power of the illumination, is dependent on a beam cross-section of the modulated light beam in the sensor region and on the modulation frequency of the modulation of the illumination, wherein the longitudinal sensor signal comprises a first component and a second component, wherein the first component is dependent on a response of the longitudinal optical sensor to a variation of the modulation of the modulated light beam and the second component is dependent on the total power of the illumination; and
at least one evaluation device, wherein the evaluation device is designed to generate at least one item of information on a longitudinal position of the object by deriving the first component and the second component from the longitudinal sensor signal, wherein the item of information on the longitudinal position of the object is dependent on the first component and the second component.

Embodiment 2: The detector according to the preceding embodiment, wherein determining the item of information on the longitudinal position of the object comprises normalizing the first component by using the second component.

Embodiment 3: The detector according to any one of the preceding embodiments, wherein the detector comprises a single large-area longitudinal optical sensor or a single pixelated optical sensor.

Embodiment 4: The detector according to the preceding embodiment, wherein the evaluation device is adapted to determine a diameter of the modulated light beam light beam by normalizing the first component by using the second component of the longitudinal sensor signal.

Embodiment 5: The detector according to the preceding embodiment, wherein the evaluation device is further adapted to compare the diameter of the modulated light beam as derived from the first component with known beam properties of the modulated light beam derived from the second component, preferably from a known dependency of a beam diameter of the modulated light beam on at least one propagation coordinate in a direction of propagation of the modulated light beam and/or from a known Gaussian profile of the modulated light beam.

Embodiment 6: The detector according to any one of the preceding embodiments, wherein the first component is related to at least one temporal variation of the longitudinal sensor signal within the response to the variation of the modulation.

Embodiment 7: The detector according to the preceding embodiment, wherein the first component is related to at least one of a rise time and a fall time of the longitudinal sensor signal within the response to the variation of the modulation.

Embodiment 8: The detector according to any one of the two preceding embodiments, wherein the second component is related to an integral of the longitudinal sensor signal over a time interval covering at least a part of the response to a variation of the total power of the illumination.

Embodiment 9: The detector according to any one of the preceding embodiments, wherein the modulation device is adapted to periodically modulate an intensity of the modulated light beam, whereby repetitive periods with respect to the intensity of the modulated light beam are generated.

Embodiment 10: The detector according to the preceding embodiment, wherein the modulation is a square modulation, a triangular modulation, or a sinusoidal modulation.

Embodiment 11: The detector according to any one of the preceding embodiments, wherein the first component is related to at least one of the rise time and the fall time of the longitudinal sensor signal within at least one of the repetitive periods of the modulation.

Embodiment 12: The detector according to the preceding embodiment, wherein the second component is related to an integral of the longitudinal sensor signal over at least one of the repetitive periods of the modulation.

Embodiment 13: The detector according to any one of the preceding embodiments, wherein the evaluation device is adapted for determining the item of information on the longitudinal position of the object by separating the first component from the second component of the longitudinal sensor signal.

Embodiment 14: The detector according to the preceding embodiment, wherein the evaluation device further comprises at least one signal splitter for splitting the longitudinal sensor signal into at least two separate signals.

Embodiment 15: The detector according to any one of the preceding embodiments, wherein the evaluation device comprises at least one first processing unit for deriving the first component and at least one second processing unit for deriving the second component of the longitudinal sensor signal.

Embodiment 16: The detector according to the preceding embodiment, wherein the first processing unit comprises at least one high-pass filter for deriving the first component and the second processing unit comprises at least one low-pass filter for deriving the second component of the longitudinal sensor signal.

Embodiment 17: The detector according to any one of the three preceding embodiments, wherein the evaluation device further comprises at least one amplifier adapted for amplifying the longitudinal sensor signal or a part thereof.

Embodiment 18: The detector according to any of the preceding embodiments, wherein the at least one longitudinal optical sensor is a transparent optical sensor.

Embodiment 19: The detector according to any of the preceding embodiments, wherein the sensor region of the longitudinal optical sensor is exactly one continuous sensor region, wherein the longitudinal sensor signal is a uniform sensor signal for the entire sensor region.

Embodiment 20: The detector according to any of the preceding embodiments, wherein the sensor region of the longitudinal optical sensor is or comprises a sensor area, the sensor area being formed by a surface of the respective device, wherein the surface faces towards the object or faces away from the object.

Embodiment 21: The detector according to any of the preceding embodiments, wherein the longitudinal optical detector is adapted to generate the longitudinal sensor signal by one or more of measuring an electrical resistance or a conductivity of at least one part of the sensor region.

Embodiment 22: The detector according to the preceding embodiment, wherein the optical detector is adapted to generate the longitudinal sensor signal by performing at least one current-voltage measurement and/or at least one voltage-current-measurement.

Embodiment 23: The detector according to any of the preceding embodiments, wherein the detector has at least two longitudinal optical sensors, wherein the longitudinal optical sensors are stacked.

Embodiment 24: The detector according to the preceding embodiment, wherein the longitudinal optical sensors form a longitudinal optical sensor stack, wherein the sensor regions of the longitudinal optical sensors are oriented perpendicular to the optical axis.

Embodiment 25: The detector according to any of the two preceding embodiments, wherein the longitudinal optical sensors are arranged such that a modulated light beam from the object illuminates all longitudinal optical sensors, preferably sequentially, wherein at least one longitudinal sensor signal is generated by each longitudinal optical sensor.

Embodiment 26: The detector according to any one of the preceding embodiments, furthermore comprising at least one illumination source.

Embodiment 27: The detector according to the preceding embodiment, wherein the illumination source is selected from: an illumination source, which is at least partly connected to the object and/or is at least partly identical to the object; an illumination source which is designed to at least partly illuminate the object with a primary radiation.

Embodiment 28: The detector according to the preceding embodiment, wherein the modulated light beam is generated by a reflection of the primary radiation on the object and/or by light emission by the object itself, stimulated by the primary radiation.

Embodiment 29: The detector according to the preceding embodiment, wherein the spectral sensitivities of the longitudinal optical sensor is covered by the spectral range of the illumination source.

Embodiment 30: The detector according to any of the four preceding embodiments, wherein the modulation device is adapted to modulate the illumination source.

Embodiment 31: The detector according to any one of the preceding embodiments, further comprising at least one transversal optical sensor, the transversal optical sensor being adapted to determine a transversal position of the modulated light beam traveling from the object to the detector, the transversal position being a position in at least one dimension perpendicular to an optical axis of the detector, the transversal optical sensor being adapted to generate at least one transversal sensor signal, wherein the evaluation device is further designed to generate at least one item of information on a transversal position of the object by evaluating the transversal sensor signal.

Embodiment 32: The detector according to the preceding embodiment, wherein the transversal optical sensor is a photo detector having at least one first electrode, at least one second electrode and at least one photoconductive material embedded in between two separate layers of a transparent conductive oxide, wherein the transversal optical sensor has a sensor area, wherein the first electrode and the second electrode are applied to different locations of one of the layers of the transparent conductive oxide, wherein the at least one transversal sensor signal indicates a position of the modulated light beam in the sensor area.

Embodiment 33: The detector according to any of the two preceding embodiments, wherein the at least one transversal optical sensor is a transparent transversal optical sensor.

Embodiment 34: The detector according to any of the three preceding embodiments, wherein the sensor area of the transversal optical sensor is formed by a surface of the transversal optical sensor, wherein the surface faces towards the object or faces away from the object.

Embodiment 35: The detector according to any of the four preceding embodiments, wherein the first electrode and/or the second electrode are a split electrode comprising at least two partial electrodes.

Embodiment 36: The detector according to the preceding embodiments, wherein at least four partial electrodes are provided.

Embodiment 37: The detector according to any one of the two preceding embodiments, wherein electrical currents through the partial electrodes are dependent on a position of the modulated light beam in the sensor area.

Embodiment 38: The detector according to the preceding embodiment, wherein the transversal optical sensor is adapted to generate the transversal sensor signal in accordance with the electrical currents through the partial electrodes.

Embodiment 39: The detector according to any of the two preceding embodiments, wherein the detector, preferably the transversal optical sensor and/or the evaluation device, is adapted to derive the information on the transversal position of the object from at least one ratio of the currents through the partial electrodes.

Embodiment 40: The detector according to any of the nine preceding embodiments, wherein the at least one transversal optical sensor is a transparent optical sensor.

Embodiment 41: The detector according to any of the ten preceding embodiments, wherein the transversal optical sensor and the longitudinal optical sensor are stacked along the optical axis such that a modulated light beam travelling along the optical axis both impinges the transversal optical sensor and the at least two longitudinal optical sensors.

Embodiment 42: The detector according to the preceding embodiment, wherein the modulated light beam subsequently passes through the transversal optical sensor and the at least one longitudinal optical sensors or vice versa.

Embodiment 43: The detector according to the preceding embodiment, wherein the modulated light beam passes through the at least one transversal optical sensor before impinging on the at least one longitudinal optical sensor.

Embodiment 44: The detector according to any of the thirteen preceding embodiments, wherein the transversal sensor signal is selected from the group consisting of a current and a voltage or any signal derived thereof.

Embodiment 45: The detector according to any of the preceding embodiments, furthermore comprising at least one transfer device.

Embodiment 46: The detector according to the preceding embodiment, wherein the modulation device is adapted to modulate the transfer device.

Embodiment 47: The detector according to any one of the preceding embodiments, wherein the detector further comprises at least one imaging device.

Embodiment 48: The detector according to the preceding claim, wherein the imaging device is located in a position furthest away from the object.

Embodiment 49: The detector according to any of the two preceding embodiments, wherein the modulated light beam passes through the at least one longitudinal optical sensor before illuminating the imaging device.

Embodiment 50: The detector according to any of the three preceding embodiments, wherein the imaging device comprises a camera.

Embodiment 51: The detector according to any of the four preceding embodiments, wherein the imaging device comprises at least one of: an inorganic camera; a monochrome camera; a multichrome camera; a full-color camera; a pixelated inorganic chip; a pixelated organic camera; a CCD chip, preferably a multi-color CCD chip or a full-color CCD chip; a CMOS chip; an IR camera; an RGB camera.

Embodiment 52: An arrangement comprising at least two detectors according to any of the preceding embodiments.

Embodiment 53: The arrangement according to any of the two preceding embodiments, wherein the arrangement further comprises at least one illumination source.

Embodiment 54: A human-machine interface for exchanging at least one item of information between a user and a machine, in particular for inputting control commands, wherein the human-machine interface comprises at least one detector according to any of the preceding embodiments relating to a detector, wherein the human-machine interface is designed to generate at least one item of geometrical information of the user by means of the detector wherein the human-machine interface is designed to assign to the geometrical information at least one item of information, in particular at least one control command.

Embodiment 55: The human-machine interface according to the preceding embodiment, wherein the at least one item of geometrical information of the user is selected from the group consisting of: a position of a body of the user; a position of at least one body part of the user; an orientation of a body of the user; an orientation of at least one body part of the user.

Embodiment 56: The human-machine interface according to any of the two preceding embodiments, wherein the human-machine interface further comprises at least one beacon device connectable to the user, wherein the human-machine interface is adapted such that the detector may generate an information on the position of the at least one beacon device.

Embodiment 57: The human-machine interface according to the preceding embodiment, wherein the beacon device comprises at least one illumination source adapted to generate at least one modulated light beam to be transmitted to the detector.

Embodiment 58: The human-machine interface according to the preceding embodiment, wherein the at least one illumination source in the beacon device comprises a modulated illumination source.

Embodiment 59: An entertainment device for carrying out at least one entertainment function, in particular a game, wherein the entertainment device comprises at least one human-machine interface according to any of the preceding embodiments referring to a human-machine interface, wherein the entertainment device is designed to enable at least one item of information to be input by a player by means of the human-machine interface, wherein the entertainment device is designed to vary the entertainment function in accordance with the information.

Embodiment 60: A tracking system for tracking the position of at least one movable object, the tracking system comprising at least one detector according to any of the preceding embodiments referring to a detector, the tracking system further comprising at least one track controller, wherein the track controller is adapted to track a series of positions of the object, each comprising at least one item of information on a position of the object at a specific point in time.

Embodiment 61: The tracking system according to the preceding embodiment, wherein the tracking system further comprises at least one beacon device connectable to the object, wherein the tracking system is adapted such that the detector may generate an information on the position of the object of the at least one beacon device.

Embodiment 62: The tracking system according to any one the two preceding embodiments, wherein the at least one detector in the tracking system comprises at least one pixelated optical sensor.

Embodiment 63: A camera for imaging at least one object, the camera comprising at least one detector according to any one of the preceding embodiments referring to a detector.

Embodiment 64: A method for an optical detection of at least one object, in particular using a detector according to any of the preceding embodiments relating to a detector, comprising the following steps:

generating at least one longitudinal sensor signal by using at least one longitudinal optical sensor, wherein the longitudinal sensor signal is dependent on an illumination of a sensor region of the longitudinal optical sensor by a modulated light beam, wherein the longitudinal sensor signal, given the same total power of the illumination, is dependent on a beam cross-section of the modulated light beam in the sensor region and on the modulation frequency of the modulation of the illumination, wherein the longitudinal sensor signal comprises a first component and a second component, wherein the first component is dependent on a response of the longitudinal optical sensor to a variation of the modulation of the modulated light beam and the second component is dependent on the total power of the illumination; and
evaluating the longitudinal sensor signal of the longitudinal optical sensor by deriving the first component and the second component from the longitudinal sensor signal, wherein the item of information on the longitudinal position of the object is determined by using the first component and the second component.

Embodiment 65: The method according to the preceding embodiment, wherein determining the item of information on the longitudinal position of the object comprises normalizing the first component by using the second component.

Embodiment 66: The use of a detector according to any of the preceding embodiments relating to a detector for a purpose of determining a position, in particular a depth of an object.

Embodiment 67: The use of a detector according to the previous embodiment, for a purpose of use, selected from the group consisting of: a distance measurement, in particular in traffic technology; a position measurement, in particular in traffic technology; an entertainment application; a security application; a human-machine interface application; a tracking application; a photography application; an imaging application or camera application; a mapping application for generating maps of at least one space.

### BRIEF DESCRIPTION OF THE FIGURES

Further optional details and features of the invention are evident from the description of preferred exemplary embodiments which follows in conjunction with the dependent claims. In this context, the particular features may be implemented alone or with features in combination.

The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 illustrates an exemplary embodiment of an optical detector according to the present invention comprising at least one longitudinal optical sensor;

FIG. 2 presents an experimental diagram which exhibits a temporal variation of the longitudinal sensor signal in a first case, in which the longitudinal optical sensor is in a focused position, and in a second case, in which the longitudinal optical sensor is in a defocused position, wherein, in both cases, the longitudinal sensor signal comprises a first component and a second component;

FIG. 3 depicts a block diagram of an exemplary signal processing unit used within the evaluation device for deriving the first component and the second component from the longitudinal sensor signal, respectively; and

FIG. 4 shows an exemplary embodiment of the optical detector and of a detector system, a human-machine interface, an entertainment device, a tracking system, and a camera, each comprising the optical detector according to the present invention.

### EXEMPLARY EMBODIMENTS

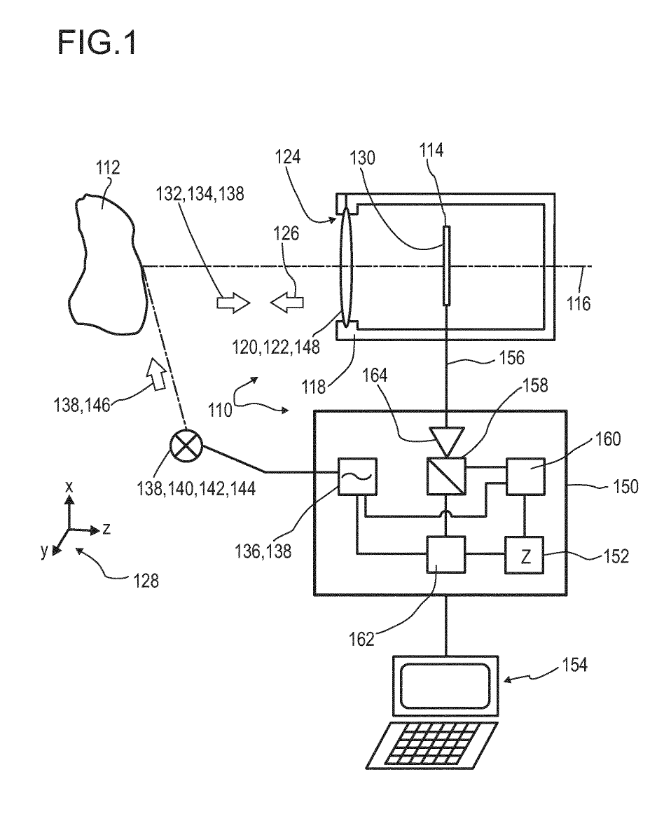

FIG. 1 illustrates, in a highly schematic illustration, an exemplary embodiment of an optical detector 110 according to the present invention, for determining a position of at least one object 112. Accordingly, the optical detector 110 comprises at least one longitudinal optical sensor 114, which, in this particular embodiment, is arranged along an optical axis 116 of the detector 110. Specifically, the optical axis 116 may be an axis of symmetry and/or rotation of the setup of the optical sensors 114. The longitudinal optical sensor 114 may be located inside a housing 118 of the detector 110. Further, at least one transfer device 120 may be comprised, preferably a refractive lens 122 and/or a convex mirror. An opening 124 in the housing 118, which may, particularly, be located concentrically with regard to the optical axis 116, preferably defines a direction of view 126 of the detector 110.

A coordinate system 128 may be defined, in which a direction parallel or antiparallel to the optical axis 116 is defined as a longitudinal direction, whereas directions perpendicular to the optical axis 116 may be defined as transversal directions. In the coordinate system 128, symbolically depicted in FIG. 1, a longitudinal direction is denoted by z and transversal directions are denoted by x and y, respectively. However, other types of coordinate systems 128 are feasible.

Further, the longitudinal optical sensor 114 is designed to generate at least one longitudinal sensor signal in a manner dependent on an illumination of a sensor region 130 by a light beam 132. Thus, according to the FiP effect, the longitudinal sensor signal, given the same total power of the illumination, is dependent on a beam cross-section of the light beam 132 in the respective sensor region 130, as will be outlined in further detail below.

According to the present invention, the light beam 132 traveling from the object to the detector is a modulated light beam 134. Herein, the modulation of the modulated light beam 134 is generated by a modulation device 136 which provides at least one modulation comprising a modulation frequency 138 in order to generate the modulated light beam 134. In this particular example as depicted in FIG. 1, the modulation device 136 provides the at least one modulated light beam 134 by modulating an illumination source 140, such as an ambient light source and/or an artificial light source, in particular a light-emitting diode 142, in manner that the illumination source 140 acts as a modulated illumination source 144, wherein an emitted light beam 146 emitted by the modulated illumination source 144 illuminates at least a part of the object 142. Thus, the modulated light beam 134 for impinging on the sensor region 130 of the longitudinal optical sensor 114 is generated by a reflection of the emitted light beam 146 as emitted by the modulated illumination source 144 into a direction of sensor region 130 of the longitudinal optical sensor 114, preferably by entering the housing 118 of the optical detector 110 through the opening 124 along the optical axis 116.

However, other embodiments (not depicted here) for generating the modulated light beam 134 in a beam path between the illumination source 140 and the object 112 and/or between the object 112 and the longitudinal optical sensor 114 may be feasible. As an example, the object 112 may be or may comprise the modulated illumination source 144, in particular the light-emitting diode 142, which may directly emit the modulated light beam 134. Alternatively or in addition, the transfer device 120, preferably the refractive lens 122, may be a modulating transfer device 148 which may be configured for modulating an incident light beam 132 in a manner that the modulated light beam 134 may be generated thereby.

Irrespective of the particular embodiment selected for generating the modulated light beam 134, the modulation device 136 providing the at least one modulation with the modulation frequency 138 constitutes a part of the optical detector 110 according to the present invention. Herein, the modulation device 136 may be a separate device within the optical detector 110 but may also be at least partially be integrated into the illumination source 140, the modulating transfer device 148, the object 112, or, as exemplarily shown in FIG. 1, into a evaluation device 150.

The evaluation device 150 is, generally, designed to generate at least one item of information on a position of the object 112 by evaluating the sensor signal of the longitudinal optical sensor 114. For this purpose, the evaluation device 150 may comprise one or more electronic devices and/or one or more software components, in order to evaluate the sensor signals, which are symbolically denoted by a longitudinal evaluation unit 152 (denoted by “z”). As will be explained below in more detail, the evaluation device 150 may be adapted to determine the at least one item of information on the longitudinal position of the object 112 by evaluating the longitudinal sensor signal of the longitudinal optical sensor 114 in a specific manner.

Generally, the evaluation device 150 may be part of a data processing device 154 and/or may comprise one or more data processing devices 154. The evaluation device 150 may be fully or partially integrated into the housing 118 and/or may fully or partially be embodied as a separate device which is electrically connected in a wireless or wire-bound fashion, such as by one or more signal leads 156 to the longitudinal optical sensor 114. The evaluation device 150 may further comprise one or more additional components, such as one or more electronic hardware components and/or one or more software components, such as one or more measurement units and/or one or more evaluation units and/or one or more controlling units (not depicted here).

As explained above, the longitudinal sensor signal as provided by the longitudinal optical sensor 114 upon impingement by the light beam 132, given the same total power of the illumination, depends on properties of the modulated light beam 134 in the sensor region 130, i.e. on both the beam cross-section of the light beam 132 in the sensor region and the modulation frequency 138 of the modulation of the illumination. According to the present invention, the longitudinal sensor signal comprises a first component and a second component, wherein the first component is dependent on a response of the longitudinal optical sensor to a variation of the modulation of the light beam 132 and the second component is dependent on the total power of the illumination. Consequently, the evaluation device 150 is designed to generate at least one item of information on a longitudinal position of the object 112 by deriving the first component and the second component from the longitudinal sensor signal.

For this purpose, the evaluation device 150 may comprise suitable means for further processing both the first component and the second component of the longitudinal sensor signal as provided by the longitudinal optical sensor 114 through the signal leads 156. It may, thus, be suitable to enable a detection of both the first component and the second component by employing suitable detection means which are especially adapted to distinguish between at least one specific property by which the first component may be distinguishable from the second component, such as by a velocity of the temporal variations of the respective components within the longitudinal optical signal. Herein, the mentioned detection means may comprise (not depicted here) a single unit which may especially be configured for this purpose.

A schematically depicted in FIG. 1, the evaluation device 150 may be adapted for determining the desired item of information on the longitudinal position of the object 112 by separating the first component of the longitudinal sensor signal from the second component of the same longitudinal sensor signal. For this purpose, the evaluation device 150 may comprise at least one signal splitter 158 adapted for splitting the longitudinal sensor signal as received by the evaluation device 150 into two separate signals which may further be processed in the evaluation device 150. Herein, the signal splitter 158 may be configured for splitting the longitudinal sensor signal into two partial signals, wherein a first partial signal may be used for determining the first component and a second partial signal may to be used for determining the second component of the longitudinal sensor signal. However, other procedures may also be feasible, such as splitting the signal in a consecutive manner.

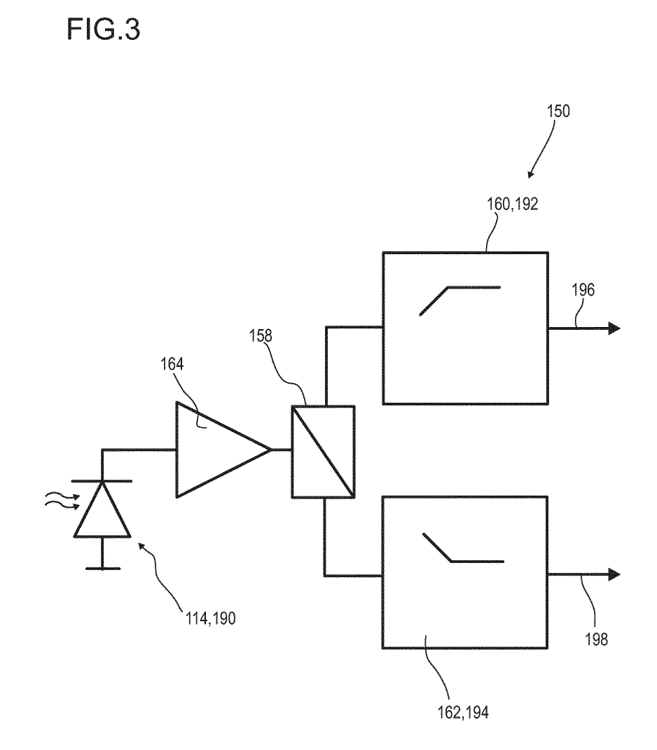

Consequently, the evaluation device 150 may, thus, comprise a first processing unit 160 for further processing the first component of the longitudinal sensor signal and a second processing unit 162 for further processing the second component of the longitudinal sensor signal. Herein, the first processing unit 160 may comprise means which are specifically adapted to evaluate the at least one specific property by which the first component can be distinguished from the second component of the longitudinal sensor signal. Similarly, the second processing unit 162 may comprise means which are specifically adapted to evaluate the at least one specific property by which the second component can be distinguished from the first component of the longitudinal sensor signal. A preferred embodiment for implementing both the first processing unit 160 and the second processing unit 162 will be presented in FIG. 3.

Further, the evaluation device 150 may comprise one or more amplifiers 164 which may be adapted for amplifying the longitudinal sensor signal or a part thereof, i.e. the longitudinal sensor signal as received by the evaluation device 150 (as depicted in FIG. 1) but also one or both of the two partial signals as generated by the signal splitter 158, in particular before and/or after their further processing in the first processing unit 160 and/or the second processing unit 162, respectively, but also before or after the longitudinal evaluation unit 152.

The optical detector 110 may have a straight beam path or a tilted beam path, an angulated beam path, a branched beam path, a deflected or split beam path or other types of beam paths. Further, the light beam 132 may propagate along each beam path or partial beam path once or repeatedly, unidirectionally or bidirectionally. Thereby, the components listed above or the optional further components listed in further detail below may fully or partially be located in front of the longitudinal optical sensors 114 and/or behind the longitudinal optical sensors 114.

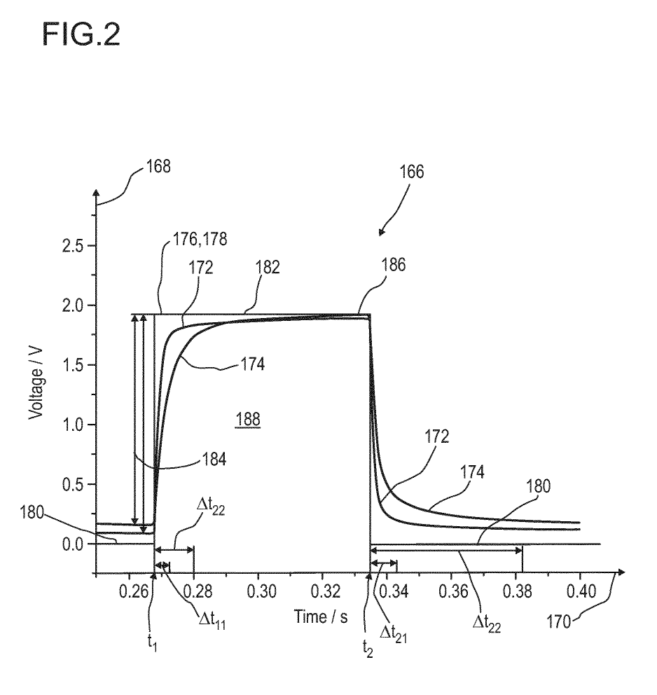

FIG. 2 presents an experimental diagram 166 which demonstrates a variation of an output voltage 168 versus time 170 as the longitudinal sensor signal of the longitudinal optical sensor 114, such as depicted in FIG. 1, which is illuminated by the modulated light beam 134, such as generated by the modulated illumination source 144, in particular the light-emitting diode 142. In this particular example, FIG. 2 comprises a first curve 172 and a second curve 174, wherein the first curve 172 exhibits the longitudinal sensor signal in a first case, in which the longitudinal optical sensor 114 is in a focused position, such as that the longitudinal optical sensor 114 is located within the modulated beam 134 in a position at or near at least one focus as generated by the transfer device 120, preferably the reflective lens 122, in the embodiment as depicted in FIG. 1. Similarly, the second curve 172 exhibits the longitudinal sensor signal in a second case, in which the longitudinal optical sensor 114 is in a defocused position, such as that the longitudinal optical sensor 114 is located within the modulated beam 134 in a position outside the at least one focus as generated by the transfer device 120, preferably the reflective lens 122, as schematically depicted in FIG. 1.

Further, FIG. 2 schematically depicts the variation of an intensity or amplitude 176 of the modulated light beam 134 versus the time 170. From FIG. 2 it may, thus, be derived that the modulated light beam 134 has a modulation shape comprising a square modulation 178. Herein, FIG. 2 only shows a single period of the square modulation 178 which stimulates the longitudinal optical sensor 114, wherein the period may subsequently be repeated, preferably, in the same fashion or, alternatively, in an amended fashion. In this particular example, the amplitude 176 of the modulated light beam 134 exhibits a first constant amplitude 180, which here substantially equals 0 V but may also acquire a value above or below 0 V, until a first point of time t₁, which approximately equals 0.268 s. According to the inherent properties of the square modulation 178, the amplitude 176 of the modulated light beam 134 instantaneously increases to a second constant amplitude 182, which here approximately equals 1.9 V, at the first point of time t₁. Thereafter, the amplitude 176 of the modulated light beam 134 remains at the second constant amplitude 182 until a second point of time t₁, which approximately equals 0.335 s, at which, again pursuant to the inherent properties of the square modulation 178, the amplitude 176 of the modulated light beam 134 instantaneously decreases back to the first constant amplitude 180. As mentioned above, the instantaneous variations as comprised by the square modulation 178 may be described as a specific external influence on the longitudinal optical sensor 114.

As can further be derived from FIG. 2, the longitudinal sensor signal depends on a response of the longitudinal optical sensor 114 to the above-described variation of the modulation of the modulated light beam 134 impinging on the longitudinal optical sensor 114. As exemplarily demonstrated here in the case of the square modulation 178, the longitudinal optical sensor 114 does not respond instantaneously to the specific external influence but rather requires additional time for following a stimulus as provided by specific external influence. Both the first curve 172 and the second curve 174 demonstrate that at first point of time t₁, at which the modulation amplitude 176 instantaneously increases, a rise time Δt₁₁ for the first curve 172 and a rise time Δt₁₂ for the second curve 174 may be observed. Herein, the rise times Δt₁₁, Δt₁₂ may be defined by a time interval an increase from a first percentage, such as 5% or 10%, to a second percentage, such as 90% or 95%, of a step height 182, wherein the step height 184 may be defined by a difference between the signal before the first point of time t₁, and the end value 186 which the signal may reach after several times, such as 5 times, 10 times or more of the rise time Δt₁₁, Δt₁₂, respectively, have been passed after the first point of time t₁. In a similar manner the corresponding fall times Δt₂₁, Δt₂₂, respectively, may be defined.

Further, FIG. 2 demonstrates that, surprisingly, the first curve 172 which exhibits the longitudinal sensor signal in the first case, in which the longitudinal optical sensor 114 is in the focused position, clearly deviates from the second curve 174 which exhibits the longitudinal sensor signal in the second case, in which the longitudinal optical sensor 114 is in the defocused position, in a manner that the second rise time Δt₁₂ belonging to the second curve 174 related to the defocused state exceeds the first rise time Δt₁₁ belonging to the first curve 172 related to the focused state. Consequently, a value as derived for the rise times Δt₁₁, Δt₁₂, respectively, may, thus, be employed to determine whether the longitudinal optical sensor 114 is in the focused state or not. In other words: Since the focal point may easily be determined from a location of the at least one transfer device 120, such as the one or more refractive lenses 122, in the detector 110, measuring the value for the rise times Δt₁₁, Δt₁₂, respectively, may be employed to determine a longitudinal distance with respect to the object 112. Further, analogous considerations may be performed with respect to the fall times Δt₂₁, Δt₂₂, respectively, for determining a longitudinal distance with respect to the object 112, too.

Further, FIG. 2 demonstrates that, apart from an offset which may be induced by performing the corresponding measurements, nevertheless, an integral 188 under the first curve 172 substantially equals the integral 188 under the second curve 174. For practical purposes, the integral 188 may be determined for each of the curves 172, 174 over an interval along the time axis 170, wherein the first point of time t₁, and an additional point of time which equals a sum of the second point of time t₂ and the respective fall time, Δt₂₁ or Δt₂₂, may be used as boundary values for actually determining a value for the integral 188. The observation that the integrals 188 under both curves 172, 174 in the experimental diagram 166 as shown in FIG. 2 are substantially equal reflects the fact that both curves 172, 174 have been recorded under the same total power of the illumination in the sensor region 130 of the longitudinal optical sensor 114. Further, FIG. 2 reveals that both curves 172, 174 have ben recorded under the same modulation conditions, such as the same modulation frequency. Consequently, the longitudinal sensor signal is only dependent on a beam cross-section of the modulated light beam 134, which may, thus, be easily determined.

On the other hand, provided the modulation remains unmodified, a change in the value of the integral 188 under subsequent curves may, thus, be used to determine a change of the total power of the illumination of the sensor region 130 of the longitudinal optical sensor 114. As a result, the total power of the illumination of the sensor region 130 may, thus, be taken into account in order to normalize the longitudinal sensor signal as determined above.

According to the present invention, the determination of the rise time and/or the fall time, respectively, of a specific curve may thus be considered as a first component which may be derived from the longitudinal sensor signal while the determination of the value of the corresponding integral 188 under the respective curve may, thus, be considered as the second component of the longitudinal sensor signal which, according to the description above, exhibits an independent behavior with respect to the first component. Consequently, the determination of the rise time or the fall time, on one hand, and the determination of the corresponding integral, on the other hand, from the same measurement curve qualify as the first component and the second component of the longitudinal sensor signal to be used in accordance with the present invention in the evaluation device 150 in order to generate the at least one item of information on the longitudinal position of the object 112.

FIG. 3, shows a block diagram of an exemplary signal processing unit to be used within the evaluation device 150 which comprises a number of components for deriving the first component and the second component from the longitudinal sensor signal, respectively. This block diagram shows the longitudinal optical sensor 114 which has been schematically depicted in a form of a light-sensitive diode 190 providing the longitudinal sensor signal to the amplifier 164 before the amplified signal is split in the signal splitter 158 into two partial signals, preferably of the same amplitude. However, in certain embodiments it may also be feasible to split the signal in the signal splitter 158 into two partial signals with different amplitudes or to split the signal in the signal splitter 158 into more than two partial signals with the same or differing amplitudes.

According to the embodiment as depicted in FIG. 3, one of the two partial signals is provided to the first processing unit 160 whereas the other of the two partial signals is provided to the second processing unit 162. Since, as described above, the first component is related here to the rise time and/or fall time of one of the curves 172, 174 which are fast varying properties while the second component is related here to the integral of one of the curves 172, 174 which is slowly varying property, it may be advantageous in particular embodiment to employ a high-pass filter 192 as the first processing unit 160 and a low-pass filter 194 as the second processing unit 162 for separately determining both the first component and the second component of the longitudinal sensor signal. As a result, a FiP signal 196 may, thus, be provided by the high-pass filter 192 while a corresponding reference illumination signal 198 may, concurrently, be provided by the low-pass filter 194. Consequently, the detector 110 according to the present invention allows determining both the FiP signal 196 and the corresponding reference illumination signal 198 by using a single longitudinal optical sensor 114 and the specifically adapted evaluation device 150 as described herein, such as in the embodiments according to FIGS. 1 and 3. However, as mentioned above, more than one longitudinal optical sensor 114 may, for various reasons, also be used in combination with the specifically adapted evaluation device 150 for performing this task.

With regard to further details comprised in FIG. 3, reference may be made to the evaluation device 150 as described in FIG. 1.

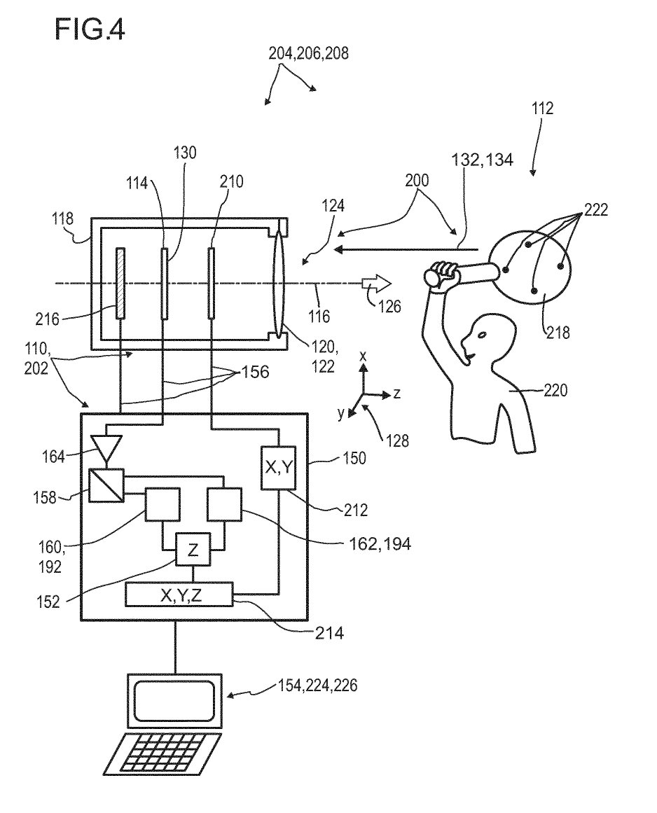

As an example, FIG. 4 shows an exemplary embodiment of a detector system 200, comprising at least one optical detector 110, such as the optical detector 110 as disclosed in one or more of the embodiments shown in FIGS. 1 and 3. Herein, the optical detector 110 may be employed as a camera 202, specifically for 3D imaging, which may be made for acquiring images and/or image sequences, such as digital video clips. Further, FIG. 4 shows an exemplary embodiment of a human-machine interface 204, which comprises the at least one detector 110 and/or the at least one detector system 200, and, further, an exemplary embodiment of an entertainment device 206 comprising the human-machine interface 204. FIG. 4 further shows an embodiment of a tracking system 208 adapted for tracking a position of at least one object 112, which comprises the detector 110 and/or the detector system 200.

With regard to the optical detector 110 and to the detector system 200, reference may be made to the full disclosure of this application. Basically, all potential embodiments of the detector 110 may also be embodied in the embodiment shown in FIG. 4. The evaluation device 150 may be connected to the at least one longitudinal optical sensor 114, in particular, by the signal leads 156. As described above, a use of two or, preferably, three longitudinal optical sensors in order to support the evaluation of the longitudinal sensor signals without any remaining ambiguity may no longer be required according to the present invention. The evaluation device 150 may further be connected to the at least one optional transversal optical sensor 210, in particular, by the signal leads 156. By way of example, the signal leads 156 may be provided and/or one or more interfaces, which may be wireless interfaces and/or wire-bound interfaces. Further, the signal leads 156 may comprise one or more drivers and/or one or more measurement devices for generating sensor signals and/or for modifying sensor signals. Further, again, the at least one transfer device 120 may be provided, in particular as the refractive lens 122 or the convex mirror. The optical detector 110 may further comprise the at least one housing 118 which, as an example, may encase one or more of components.

Further, the evaluation device 150 may fully or partially be integrated into the optical sensors 114, 210 and/or into other components of the optical detector 110. The evaluation device 150 may also be enclosed into the housing 118 and/or into a separate housing. The evaluation device 150 may comprise one or more electronic devices and/or one or more software components, in order to evaluate the sensor signals, which are symbolically denoted by the longitudinal evaluation unit 152 (denoted by “z”) and a transversal evaluation unit 212 (denoted by “xy”) and. By combining results derived by these evolution units, a position information 214, preferably a three-dimensional position information, may be generated (denoted by “x, y, z”).

Further, the optical detector 110 and/or to the detector system 200 may comprise an imaging device 216 which may be configured in various ways. Thus, as depicted in FIG. 4, the imaging device 216 can for example be part of the detector 110 within the detector housing 118. Herein, the imaging device signal may be transmitted by one or more imaging device signal leads 156 to the evaluation device 150 of the detector 110. Alternatively, the imaging device 216 may be separately located outside the detector housing. The imaging device 216 may be fully or partially transparent or intransparent. The imaging device 216 may be or may comprise an organic imaging device or an inorganic imaging device. Preferably, the imaging device 216 may comprise at least one matrix of pixels, wherein the matrix of pixels may particularly be selected from the group consisting of: an inorganic semiconductor sensor device such as a CCD chip and/or a CMOS chip; an organic semiconductor sensor device.

In the exemplary embodiment as shown in FIG. 4, the object 112 to be detected, as an example, may be designed as an article of sports equipment and/or may form a control element 218, the position and/or orientation of which may be manipulated by a user 220. Thus, generally, in the embodiment shown in FIG. 4 or in any other embodiment of the detector system 200, the human-machine interface 204, the entertainment device 206 or the tracking system 208, the object 112 itself may be part of the named devices and, specifically, may comprise the at least one control element 218, specifically, wherein the at least one control element 218 has one or more beacon devices 222, wherein a position and/or orientation of the control element 218 preferably may be manipulated by the user 220. As an example, the object 112 may be or may comprise one or more of a bat, a racket, a club or any other article of sports equipment and/or fake sports equipment. Other types of objects 112 are possible. Further, the user 220 may be considered as the object 112, the position of which shall be detected. As an example, the user 220 may carry one or more of the beacon devices 222 attached directly or indirectly to his or her body.

The optical detector 110 may be adapted to determine at least one item on a longitudinal position of one or more of the beacon devices 222 and, optionally, at least one item of information regarding a transversal position thereof, and/or at least one other item of information regarding the longitudinal position of the object 112 and, optionally, at least one item of information regarding a transversal position of the object 112. Particularly, the optical detector 110 may be adapted for identifying colors and/or for imaging the object 112, such as different colors of the object 112, more particularly, the color of the beacon devices 222 which might comprise different colors. The opening in the housing 118, which, preferably, may be located concentrically with regard to the optical axis 116 of the detector 110, may preferably define a direction of a view of the optical detector 110.

According to the present invention, the modulation device 136 may be a direct part of the detector 110, such as integrated into the evaluation device 150. However, further pursuant to the present invention, the modulation device 136 may be an indirect part of the detector 110, in particular comprised within the illumination source 140 and/or in within the object 112. In the particular embodiment as depicted in FIG. 4, the beacon devices 222 and/or the respective control element 218 may comprise the modulation device 136 adapted to provide the modulation, such as the modulation frequency 138, configured for providing the modulated light beam 134 traveling from the object 112, which in this particular embodiment comprises the control device 218 and the beacon devices 222, to the optical sensors 114, 210 and, subsequently, to the imaging device 216.

Consequently, the modulated light beam 134 may impinge longitudinal optical sensor 114 for providing the longitudinal sensor signal comprising the first component and the second component for further evaluation within the evaluation device 150. As schematically depicted in FIG. 4, the evaluation device 150 comprises the amplifier 164 adapted to amplify the received longitudinal optical signal, the signal splitter configured for splitting the amplified signal into two partial signals which are further processed as the first component in the high-pass filter 192 as a preferred example for the first processing unit 160, thus providing the FiP signal 196, and as the second component in the low-pass filter 194 as a preferred example for the second processing unit 162, thus providing the reference illumination signal 198. As described above, the FiP signal 196 and the reference illumination signal 198 are combined in order to determine the depth of the object 112 by using the longitudinal evaluation unit 152 (denoted by “z”).

The optical detector 110 may be adapted for determining the position of the at least one object 112. Additionally, the optical detector 110, specifically an embodiment including the camera 202, may be adapted for acquiring at least one image of the object 112, preferably a 3D-image. As outlined above, the determination of a position of the object 112 and/or a part thereof by using the optical detector 110 and/or the detector system 200 may be used for providing a human-machine interface 204, in order to provide at least one item of information to a machine 224. In the embodiments schematically depicted in FIG. 4, the machine 224 may be or may comprise at least one computer and/or a computer system comprising the data processing device 154. Other embodiments are feasible. The evaluation device may be a computer and/or may comprise a computer and/or may fully or partially be embodied as a separate device and/or may fully or partially be integrated into the machine 224, particularly the computer. The same holds true for a track controller 226 of the tracking system 208, which may fully or partially form a part of the evaluation device and/or the machine 224.

Similarly, as outlined above, the human-machine interface 204 may form part of the entertainment device 206. Thus, by means of the user 220 functioning as the object 112 and/or by means of the user 220 handling the object 112 and/or the control element 218 functioning as the object 112, the user 220 may input at least one item of information, such as at least one control command, into the machine 224, particularly the computer, thereby varying the entertainment function, such as controlling the course of a computer game.

### List of Reference Numbers

110 detector

112 object

114 longitudinal optical sensor

116 optical axis

118 housing

120 transfer device

122 refractive lens

124 opening

126 direction of view

128 coordinate system

130 sensor region

132 light beam

134 modulated light beam

136 modulation device

138 modulation frequency

140 illumination source

142 light-emitting diode

144 modulated illumination source

146 emitted light beam

148 modulated transfer device

150 evaluation device

152 longitudinal evaluation unit

154 data processing device

156 signal leads

158 signal splitter

160 first processing unit

162 second processing unit

164 amplifier

166 experimental diagram

168 output voltage

170 time

172 first curve

174 second curve

176 modulation amplitude

178 square modulation

180 first constant amplitude

182 second constant amplitude

184 step height

186 end value

188 integral

190 light-sensitive diode

192 high-pass filter

194 low-pass filter

196 FiP signal

198 reference illumination signal

200 detector system

202 camera

204 human-machine interface

206 entertainment device

208 tracking system

210 transversal optical sensor

212 transversal evaluation unit

214 position information

216 imaging device

218 control element

220 user

222 beacon device

224 machine

226 track controller

1. A detector for an optical detection of at least one object, comprising:
at least one modulation device, wherein the modulation device is capable of generating at least one modulated light beam traveling from the object to the detector;
at least one longitudinal optical sensor, wherein the longitudinal optical sensor has at least one sensor region, wherein the longitudinal optical sensor is designed to generate at least one longitudinal sensor signal in a manner dependent on an illumination of the sensor region by the modulated light beam, wherein the longitudinal sensor signal, given the same total power of the illumination, is dependent on a beam cross-section of the modulated light beam in the sensor region and on a modulation frequency of the modulation of the illumination, wherein the longitudinal sensor signal comprises a first component and a second component, wherein the first component is dependent on a response of the longitudinal optical sensor to a variation of the modulation of the modulated light beam and the second component is dependent on a total power of the illumination; and
at least one evaluation device wherein the evaluation device is designed to generate at least one item of information on a longitudinal position of the object by deriving the first component and the second component from the longitudinal sensor signal, wherein an item of information on the longitudinal position of the object is dependent on the first component and the second component.

2. The detector according to claim 1, wherein determining the item of information on the longitudinal position of the object comprises normalizing the first component by using the second component.

3. The detector according to claim 1, wherein the detector comprises a single large-area longitudinal optical sensor or a single pixelated optical sensor.

4. The detector according to claim 1, wherein the evaluation device is adapted to determine a diameter of the modulated light beam by normalizing the first component by using the second component of the longitudinal sensor signal.

5. The detector according to claim 4, wherein the evaluation device is further adapted to compare the diameter of the modulated light beam as derived from the first component with known beam properties of the modulated light beam derived from the second component.

6. The detector according to claim 1, wherein the first component is related to at least one temporal variation of the longitudinal sensor signal within the response to the variation of the modulation.

7. The detector according to claim 6, wherein the first component is related to at least one of a rise time and a fall time of the longitudinal sensor signal within the response to the variation of the modulation.

8. The detector according to claim 1, wherein the second component is related to an integral of the longitudinal sensor signal over a time interval covering at least a part of the response to a variation of the total power of the illumination.

9. The detector according to claim 1, wherein the modulation device is adapted to periodically modulate an intensity of the modulated light beam, whereby repetitive periods with respect to the intensity of the modulated light beam are generated.

10. The detector according to claim 9, wherein the first component is related to at least one of a rise time and a fall time of the longitudinal sensor signal within at least one of the repetitive periods of the modulation.

11. The detector according to claim 10, wherein the second component is related to an integral of the longitudinal sensor signal over at least one of the repetitive periods of the modulation.

12. The detector according to claim 1, wherein the evaluation device is adapted for determining the item of information on the longitudinal position of the object by separating the first component from the second component of the longitudinal sensor signal.

13. The detector according to claim 12, wherein the evaluation device further comprises at least one signal splitter for splitting the longitudinal sensor signal into at least two separate signals.

14. The detector according to claim 1, wherein the evaluation device comprises at least one first processing unit for deriving the first component and at least one second processing unit for deriving the second component of the longitudinal sensor signal.

15. The detector according to claim 14, wherein the first processing unit comprises at least one high-pass filter for deriving the first component and the second processing unit comprises at least one low-pass filter for deriving the second component of the longitudinal sensor signal.

16. The detector according to claim 14, wherein the evaluation device further comprises at least one amplifier adapted for amplifying the longitudinal sensor signal or a part thereof.

17. The detector according to claim 1, wherein the detector further comprises a transversal optical sensor, the transversal optical sensor being adapted to determine a transversal position of the modulated light beam traveling from the object to the detector, the transversal position being a position in at least one dimension perpendicular an optical axis of the detector, the transversal optical sensor being adapted to generate at least one transversal sensor signal, wherein the evaluation device is further designed to generate at least one item of information on a transversal position of the object by evaluating the transversal sensor signal.

18. The detector according to claim 17, wherein the transversal optical sensor further comprises at least one split electrode, the split electrode having at least two partial electrodes, wherein electrical currents through the partial electrodes are dependent on a position of the modulated light beam in a sensor area, wherein the transversal optical sensor is adapted to generate the transversal sensor signal in accordance with the electrical currents through the partial electrodes.

19. The detector according to claim 1, wherein the detector comprises a stack comprising at least one longitudinal optical sensor and at least one transversal optical sensor, wherein the longitudinal optical sensor and the transversal optical sensor are transparent optical sensors.

20. The detector according to claim 1, furthermore further comprising:
at least one illumination source.

21. The detector according to claim 20, wherein the modulation device is adapted to modulate the illumination source.

22. The detector according to claim 1, furthermore further comprising:
at least one transfer device.

23. The detector according to claim 22, wherein the modulation device is adapted to modulate the transfer device.

24. The detector according to claim 1, furthermore further comprising:
at least one imaging device.

25. The detector according to claim 24, wherein the imaging device comprises a camera.

26. A human-machine interface for exchanging at least one item of information between a user and a machine, wherein the human-machine interface comprises at least one detector according to any claim 1, wherein the human-machine interface is designed to generate at least one item of geometrical information of the user via the detector, wherein the human-machine interface is designed to assign to the geometrical information at least one item of information.

27. An entertainment device for carrying out at least one entertainment function, wherein the entertainment device comprises at least one human-machine interface according to claim 26, wherein the entertainment device is designed to enable at least one item of information to be input by a player via the human-machine interface, wherein the entertainment device is designed to vary the entertainment function in accordance with the information.

28. A tracking system for tracking a position of at least one movable object, the tracking system comprising:
at least one detector according to claim 1, and
at least one track controller,
wherein the track controller is adapted to track a series of positions of the object, each position comprising at least one item of information on at least a longitudinal position of the object at a specific point in time.

29. A camera for imaging at least one object, the camera comprising:
at least one detector according to claim 1.

30. A method for an optical detection of at least one object, the method comprising:
generating at least one longitudinal sensor signal by using at least one longitudinal optical sensor, wherein the longitudinal sensor signal is dependent on an illumination of a sensor region of the longitudinal optical sensor by a modulated light beam, wherein the longitudinal sensor signal, given the same total power of the illumination, is dependent on a beam cross-section of the modulated light beam in the sensor region and on a modulation frequency of a modulation of the illumination, wherein the longitudinal sensor signal comprises a first component and a second component, wherein the first component is dependent on a response of the longitudinal optical sensor to a variation of the modulation of the modulated light beam and the second component is dependent on the total power of the illumination; and
evaluating the longitudinal sensor signal of the longitudinal optical sensor by deriving the first component and the second component from the longitudinal sensor signal, wherein the item of information on the longitudinal position of the object is determined by using the first component and the second component.

31. The method according to claim 30, wherein determining the item of information on the longitudinal position of the object comprises normalizing the first component by using the second component.

32. An instrument, comprising:
the detector according to claim 1,
wherein the instrument is for an application selected from the group consisting of: a distance measurement; a position measurement; an entertainment application; a security application; a human-machine interface application; a tracking application; a photography application; an imaging application or camera application; a mapping application for generating maps of at least one space.
